(19) United States
(12) Patent Application Publication
(10) Pub. No.: US 2026/0138386 A1
(43) Pub. Date: May 21, 2026

(54) MEDIUM PROCESSING APPARATUS AND IMAGE FORMING SYSTEM

(71) Applicant: Dai IWAMA, Aichi (JP)

(72) Inventor: Dai IWAMA, Aichi (JP)

(73) Assignee: ETRIA Co., Ltd., Kanagawa (JP)

(21) Appl. No.: 19/375,908

(22) Filed: Oct. 31, 2025

(30) Foreign Application Priority Data
Nov. 15, 2024 (JP) 2024-199886
Jul. 2, 2025 (JP) 2025-112455

(51) Int. Cl. B41J 27/20; B41J 13/00; B41J 13/02; B41J 13/08

(52) U.S. Cl. CPC B41J 27/20; B41J 13/0009; B41J 13/02; B41J 13/08

(57) ABSTRACT

A medium processing apparatus includes a liquid applier and a processing device. The liquid applier applies liquid to a medium. The processing device performs a process on a medium bundle to which the liquid has been applied by the liquid applier. The liquid applier includes a liquid application member, a liquid storage tank, a liquid supplier, and a presser. The liquid application member contacts with the medium and applies the liquid to the medium. The liquid storage tank has an internal space storing the liquid, and an outer wall defining the internal space and having an elastic wall elastically deformable to reduce a volume of the internal space. The liquid supplier supplies the liquid stored in the internal space of the liquid storage tank to the liquid application member. The presser presses the elastic wall from outside the liquid storage tank to reduce the volume of the internal space.

### CROSS-REFERENCE TO RELATED APPLICATIONS

This patent application is based on and claims priority pursuant to 35 U.S.C. § 119(a) to Japanese Patent Application Nos. 2024-199886, filed on Nov. 15, 2024, and 2025-112455, filed on Jul. 2, 2025, in the Japan Patent Office, the entire disclosure of each of which is hereby incorporated by reference herein.

### BACKGROUND

### Technical Field

Embodiments of the present disclosure relate to a medium processing apparatus and an image forming system incorporating the medium processing apparatus.

### Related Art

Medium processing apparatuses have been proposed that bind sheet-shaped media, on which images are formed by an image forming apparatus, into a bundle of media. Some medium processing apparatuses include a crimper that can perform so-called “crimp binding” without metal staples from a viewpoint of resource saving and reduction in environmental load. Specifically, the crimper sandwiches a sheet bundle (multiple media) with serrated binding teeth to press and deform the sheet bundle.

An increased number of media of the crimper hamper the binding teeth in biting into the medium bundle and may cause some sheets to peel off from the bound sheets. Thus, the crimp binding has some difficulties in keeping the sheet bundle bound as appropriate. Accordingly, in order to facilitate biting of the binding teeth into a medium bundle, some of medium processing apparatuses that perform crimp binding include a liquid applier that applies liquid in advance to a position at which binding teeth come into contact with the sheet.

However, in the liquid applier in the art, a liquid application member that applies liquid by abutting on a medium is connected to one end, and the other end is immersed in the liquid in the liquid storage tank. The liquid supply member supplies the liquid from the liquid storage tank to the liquid application member by capillary action. Therefore, there is a problem that it takes time to supply the liquid to the liquid application member.

### SUMMARY

Embodiments of the present disclosure described herein provide a novel medium processing apparatus including a liquid applier and a processing device. The liquid applier applies liquid to a medium. The processing device performs a process on a medium bundle including the medium to which the liquid has been applied by the liquid applier. The liquid applier includes a liquid application member, a liquid storage tank, a liquid supplier, and a presser. The liquid application member contacts with the medium and apply the liquid to the medium. The liquid storage tank has an internal space storing the liquid, and an outer wall defining the internal space and having an elastic wall elastically deformable to reduce a volume of the internal space. The liquid supplier supplies the liquid stored in the internal space of the liquid storage tank to the liquid application member. The presser presses the elastic wall from outside the liquid storage tank to reduce the volume of the internal space.

Further, embodiments of the present disclosure described herein provide an image forming system including an image forming apparatus to form an image on a medium, and the above-described to process the medium having the image formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system;

FIG. 2 is a diagram illustrating an internal structure of a post-processing apparatus according to a first embodiment;

FIG. 3 is a schematic view of an edge binder viewed from an upstream side in a conveyance direction;

FIG. 4 is a schematic view of the edge binder viewed from a liquid applier in a main scanning direction;

FIGS. 5A and 5B are schematic diagrams illustrating a configuration of a crimper of an edge binder;

FIG. 6 is a schematic view of a staple binder viewed from an upstream side in the conveyance direction;

FIG. 7 is a schematic view of a modification of the staple binder viewed from an upstream side in the conveyance direction;

FIGS. 8A and 8B are views illustrating a location and configuration of a second liquid storage tank in the post-processing apparatus;

FIG. 9 including 9(A), 9(B) and 9(C) is a diagram illustrating a configuration of attachment and detachment of the second liquid storage tank in the post-processing apparatus;

FIG. 10 is a hardware configuration diagram of a control block to control the post-processing apparatus according to the first embodiment;

FIG. 11 is a flowchart of binding process performed by an edge binder;

FIGS. 12A, 12B, 12C and 12D are diagrams illustrating the positions of the liquid applier and the crimper during a one-point binding process by the edge binder;

FIGS. 13A, 13B, 13C, 13D, 13E, 13F, 13G and 13H are diagrams illustrating the positions of the liquid applier and the crimper during a two-point binding process by the edge binder;

FIG. 14 is a configuration diagram of the liquid applier of the edge binder;

FIGS. 15A, 15B and 15C are diagrams illustrating a change in the amount of liquid in a liquid storage tank in a dry state of a liquid supply member of the liquid applier of FIG. 14;

FIG. 16 including FIGS. 16A and 16B is a flowchart of a liquid supply determination process according to the present embodiment;

FIG. 17 is a diagram illustrating liquid leakage that might occur in a first liquid storage tank according to the present embodiment;

FIG. 18 is a graph illustrating a relation between an output value of a first liquid level sensor and a liquid detection threshold value in a time series manner according to the present embodiment;

FIGS. 19A and 19B are schematic views of the liquid applier when a liquid application member is at a liquid application position and a separated position;

FIGS. 20A and 20B are side views of a main part of a liquid applier according to a modification;

FIGS. 21A, 21B and 21C are diagrams illustrating a relationship between an elastic wall and a pressing member;

FIGS. 22A, 22B, 22C, 22D, 22E and 22F are diagrams illustrating an example in which the pressing member is provided in the staple binder;

FIGS. 23A, 23B and 23C are diagrams illustrating an example in which the pressing member is provided in the liquid applier;

FIGS. 24A, 24B, 24C, 24D and 24E are diagrams for describing movement of the pressing member;

FIGS. 25A and 25B are diagrams illustrating an example in which the pressing member is provided in the crimper;

FIGS. 26A, 26B, 26C, 26D, 26E and 26F are diagrams illustrating an example in which the pressing member is moved by a dedicated drive source;

FIGS. 27A, 27B, 27C, 27D, 27E and 27F are diagrams illustrating an example in which the elastic wall is pressed by the pressing member in conjunction with liquid applying operation of the liquid applier;

FIG. 28 is a flowchart of a process for promoting supply of liquid to the liquid application member when a power source is turned on;

FIG. 29 is a flowchart of a process for promoting supply of liquid to the liquid application member during liquid application to a sheet;

FIG. 30 is a diagram illustrating an internal structure of a post-processing apparatus according to a second embodiment;

FIGS. 31A, 31B and 31C are views of an internal tray according to the second embodiment, viewed from a thickness direction of a sheet;

FIG. 32 is a schematic view of a crimper according to the second embodiment viewed from a downstream side in the conveyance direction;

FIGS. 33A and 33B are views of a liquid applier according to the second embodiment, viewed from a thickness direction of a sheet;

FIGS. 34A, 34B and 34C are cross-sectional views of the liquid applier, taken along a line XXV-XXV of FIGS. 33A and 33B;

FIGS. 35A, 35B and 35C are cross-sectional views of the liquid applier taken along a line XXVI-XXVI of FIGS. 33A and 33B;

FIG. 36 is a hardware configuration diagram of a control block of the post-processing apparatus according to the second embodiment;

FIG. 37 is a flowchart of post-processing of the post-processing apparatus according to the second embodiment;

FIG. 38 is a diagram illustrating an overall configuration of an image forming system according to a modification of the above embodiments of the present disclosure;

FIGS. 39A and 39B are diagrams illustrating Modification 1 of a controller of the post-processing apparatus; and

FIGS. 40A and 40B are diagrams illustrating Modification 2 of a controller of the post-processing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

Referring now to the drawings, embodiments of the present disclosure are described below. As used herein, the singular forms “a,” “an,” and “the” are intended to include the plural forms as well, unless the context clearly indicates otherwise.

### Embodiment of Image Forming System

A description is given below of an image forming system 1 according to the present invention, with reference to the drawings.

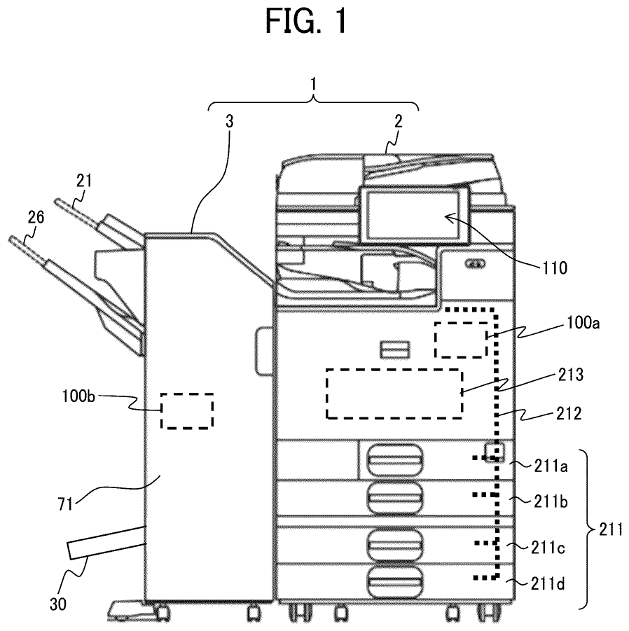

FIG. 1 is a diagram illustrating an overall configuration of the image forming system 1 according to an embodiment of the present invention.

The image forming system 1 has, for example, an image forming function of forming an image on a sheet as a type of sheet-like medium, and a post-processing function of performing predetermined post-processing on a sheet on which an image is formed. As illustrated in FIG. 1, the image forming system 1 includes an image forming apparatus 2 including the image forming function and a post-processing apparatus 3 serving as a medium processing apparatus including the post-processing function, according to the embodiment of the present disclosure. In the image forming system 1, the image forming apparatus 2 and the post-processing apparatus 3 operate in conjunction with each other.

In the present embodiment, the sheet-shaped medium to be processed in the image forming system 1 is assumed to be a sheet of “paper”. However, the object to be processed according to the present embodiment is not limited to a sheet of paper. For example, any material or specification may be used as long as an image can be formed on a medium in a known image forming process and the medium is a target of the image forming process. Examples of the medium include a medium that can be an object of a folding process or a binding process, and the material and specification of the medium are not limited to any particular material and specification.

The image forming apparatus 2 forms an image on a sheet and ejects the sheet having the image to the post-processing apparatus 3. The image forming apparatus 2 includes sheet trays 211 (211a, 211b, 211c, and 211d) that accommodate the sheets, a conveyor 212 that conveys the sheet accommodated in the sheet tray 211, and an image former 213 that forms an image on the sheet conveyed by the conveyor 212. The image former 213 may be an inkjet system that forms an image using ink or an electrophotographic system that forms an image using toner. The image forming apparatus 2 also includes a controller 100a that controls various operations of the conveyor 212 and the image former 213. Since the image forming apparatus 2 has a typical configuration, a detailed description of the configuration is omitted.

Sheets of paper are widely known as an example of sheet-shaped media. In the following description, a sheet-shaped medium as a medium to be processed is referred to as a “sheet P”. In addition, when describing a bundle of media, a “sheet bundle Pb” configured by bundling sheets of paper as a plurality of media is used as an example.

### First Embodiment of Post-Processing Apparatus

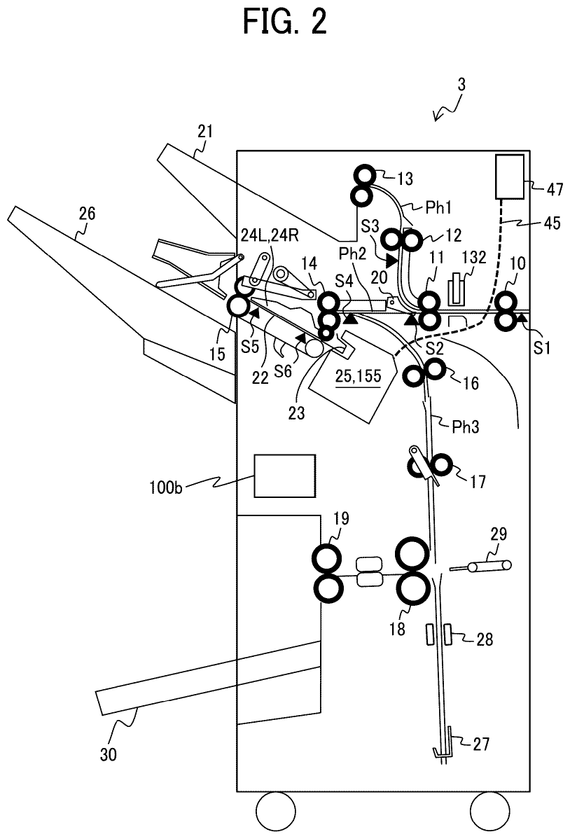

FIG. 2 is a diagram illustrating an internal structure of the post-processing apparatus 3 according to the first embodiment.

The post-processing apparatus 3 has a function that performs given post-processing on the sheet P on which an image is formed by the image forming apparatus 2. An example of the post-processing according to the present embodiment is a “crimp binding process” of binding a bundle of multiple sheets P on which an image is formed as a medium bundle (referred to as “sheet bundle Pb”) without staples. Another example of the post-processing according to the present embodiment is a “stapling process” of binding a sheet bundle Pb as a medium bundle with staples.

In the present embodiment, a description is given mainly of a liquid application process in a crimp binding process. However, the liquid application process performed in connection with the stapling process is similar to the liquid application process in the crimp binding process. In the following description, the term “binding process” indicates both the “crimp binding process” and the “stapling process”, and is not limited to a binding method (whether binding is performed using staples or binding is performed by pressing and deforming without staples).

More particularly, the “crimp binding process” according to the present embodiment is a process of applying pressure to a binding position corresponding to a part of the sheet bundle Pb to deform the binding position by a crimper 32, and entangling fibers of the overlapping sheets P to bind the sheets P together. The crimp binding process partially binds the overlapping portions of the sheets P together to form a sheet bundle Pb. This crimp binding process is referred to as “crimp binding” in the following description. The “binding process” (including both the crimp binding and the staple binding) that is executable by the post-processing apparatus 3 includes an edge binding process of binding the edge of the sheet bundle Pb and a saddle binding process of binding the central portion of the sheet bundle Pb.

The post-processing apparatus 3 includes conveyance roller pairs 10 to 19 as a conveyor and a switching member 20. The conveyance roller pairs 10 to 19 convey, inside the post-processing apparatus 3, the sheet P supplied from the image forming apparatus 2. More particularly, the conveyance roller pairs 10 to 13 convey the sheet P along a first conveyance path Ph1. The conveyance roller pairs 14 and 15 convey the sheet P along a second conveyance path Ph2. Further, the conveyance roller pairs 16 to 19 convey the sheet P along a third conveyance path Ph3. A hole punch 132 is disposed between the conveyance roller pair 10 and the conveyance roller pair 11. The hole punch 132 performs punching on a sheet P conveyed by the conveyance roller pair 10 and the conveyance roller pair 11. The post-processing apparatus 3 further includes a controller 100b as a control device. The controller 100b controls the operation of driving members in the post-processing apparatus 3 such as the conveyance roller pairs 10 to 19 and the switching member 20, and acquires detection results from various sensors as a detector. Details of the controller 100b will be described below.

The first conveyance path Ph1 is a path extending to a first ejection tray 21 from a supply port through which the sheet P is supplied from the image forming apparatus 2. The second conveyance path Ph2 is a path branching from the first conveyance path Ph1 between the conveyance roller pair 11 and the conveyance roller pair 14 in a conveyance direction of the sheet and extending to a second ejection tray 26 via an internal tray 22. The third conveyance path Ph3 is a path branching from the first conveyance path Ph1 between the conveyance roller pair 11 and the conveyance roller pair 14 in the conveyance direction and extending to an ejection tray 30.

The switching member 20 is disposed at a branching position of the first conveyance path Ph1 and the second conveyance path Ph2. The switching member 20 can be switched between a first position and a second position. The switching member 20 in a first position guides the sheet P to be ejected to the first ejection tray 21 through the first conveyance path Ph1. The switching member 20 in a second position guides the sheet P conveyed through the first conveyance path Ph1 to the second conveyance path Ph2. The conveyance roller pair 14 is rotated in reverse at the timing when the trailing edge of the sheet P that has entered the second conveyance path Ph2 passes through the branching position of the second conveyance path Ph2 and the third conveyance path Ph3. Thus, the sheet P is guided to the third conveyance path Ph3. The post-processing apparatus 3 further includes multiple sensors S1 to S6 that detect the positions of the sheet P in the conveyance path Ph1, the second conveyance path Ph2, and the third conveyance path Ph3. Each of the multiple sensors S1 to S6 is indicated by a black triangle in FIG. 2.

The post-processing apparatus 3 includes a first ejection tray 21. The sheet P that is output through the first conveyance path Ph1 is placed on the first ejection tray 21. Among the sheets P supplied from the image forming apparatus 2, a sheet P not subjected to the binding process is ejected to the first ejection tray 21.

The post-processing apparatus 3 further includes the internal tray 22 serving as a stacker on which a sheet P or a sheet bundle Pb is placed, an edge-binding end fence 23, side fences 24L and 24R, an edge binder 25, a staple binder 155, and the second ejection tray 26. The internal tray 22, the edge-binding end fence 23, the side fences 24L and 24R, the edge binder 25, and the staple binder 155 perform the edge binding process on the sheet bundle Pb including multiple sheets P conveyed from the second conveyance path Ph2 to the internal tray 22. Among the sheets P supplied from the image forming apparatus 2, the sheet bundle Pb subjected to the edge binding process is ejected to the second ejection tray 26.

The “edge binding process” here represents a binding process performed by the edge binder 25 and the staple binder 155. Specifically, the “edge binding process” includes, but is not limited to, a “parallel binding process” that binds the sheet bundle Pb along one side of the sheet bundle Pb parallel to a main scanning direction, an “oblique binding process” that binds a corner of the sheet bundle Pb, and a “vertical binding process” that binds the sheet bundle Pb along one side of the sheet bundle Pb parallel to the conveyance direction.

In the following description, a direction in which the sheet P is conveyed from the conveyance roller pair 15 toward the edge-binding end fence 23 is defined as a “conveyance direction”. In other words, the “conveyance direction” in the present specification corresponds to a direction in which the sheet P output from the image forming apparatus 2 is moved toward the second ejection tray 26 by, for example, the conveyance roller pair 10 and is then changed by the conveyance roller pair 15 to move toward the edge-binding end fence 23 as a direction different from the direction toward the second ejection tray 26. A direction that is orthogonal to the conveyance direction and the thickness direction of the sheet P, that is, the width direction of the sheet P is defined as a “main scanning direction”.

The multiple sheets P conveyed in order via the second conveyance path Ph2 is temporarily stacked on the internal tray 22. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform the edge binding process on the sheet bundle Pb aligned by the edge-binding end fence 23 and the side fences 24L and 24R. The conveyance roller pair 15 ejects the sheet bundle Pb subjected to the edge binding process to the second ejection tray 26.

The post-processing apparatus 3 further includes a saddle-binding end fence 27, a saddle binder 28, a sheet folding blade 29, and the ejection tray 30. The saddle-binding end fence 27, the saddle binder 28, and the sheet folding blade 29 perform the saddle binding process on the sheet bundle Pb of the sheets P that are conveyed through the third conveyance path Ph3. Among the sheets P supplied from the image forming apparatus 2, the sheet bundle Pb subjected to the saddle binding process is ejected to the ejection tray 30.

The saddle-binding end fence 27 aligns the positions, in the conveyance direction, of the multiple sheets P sequentially conveyed through the third conveyance path Ph3. The saddle-binding end fence 27 is movable in a direction in which the sheet P is conveyed toward the saddle-binding end fence 27 and a reverse direction (vertical direction in FIG. 2) so that the center of the sheet bundle Pb is positioned at a binding position facing the saddle binder 28 and a folding position facing the sheet folding blade 29. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pair 18 and the conveyance roller pair 19 eject the sheet bundle Pb subjected to the saddle binding process to the ejection tray 30.

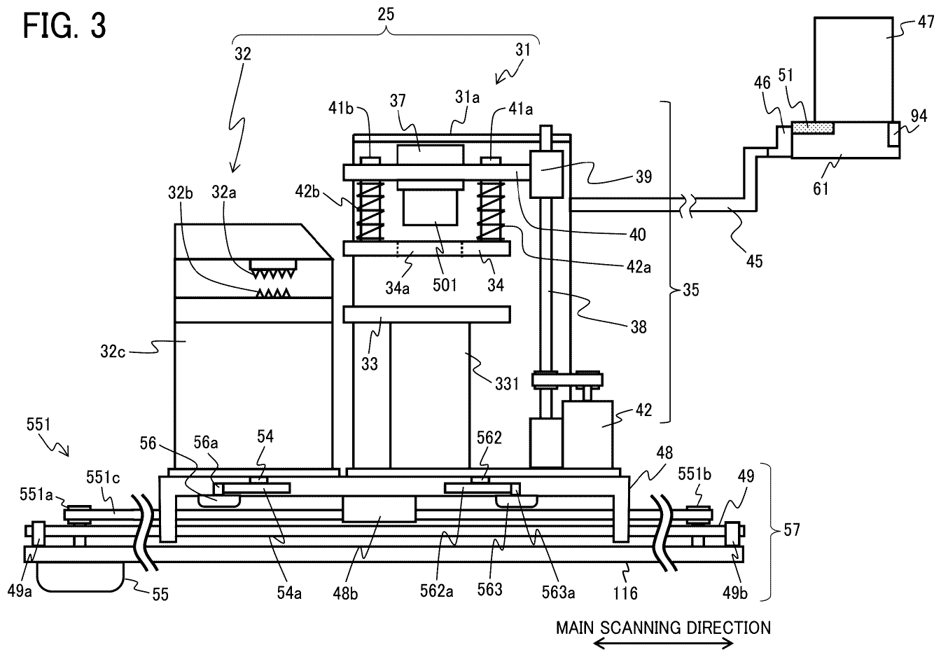

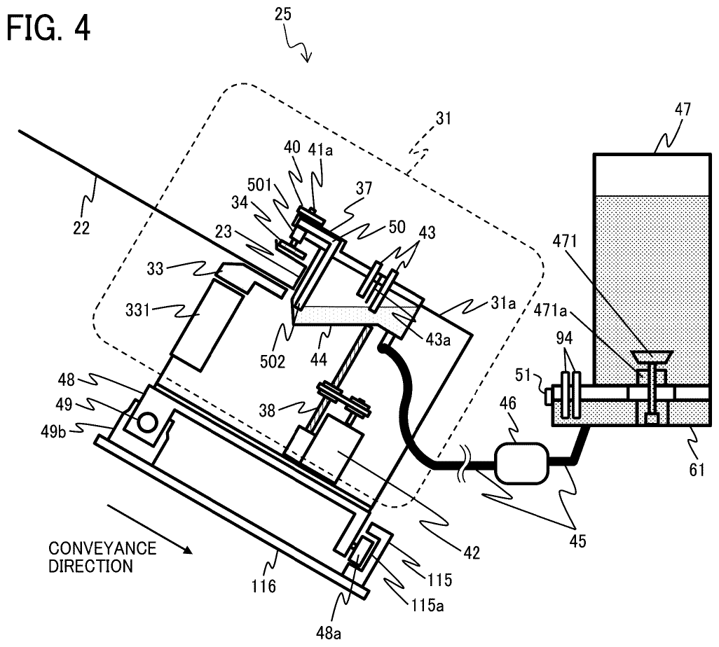

As illustrated in FIGS. 3 and 4 described below, the post-processing apparatus 3 includes a liquid application member 501 and a liquid supply member 50 as a part of the liquid applier and a first liquid storage tank 44 as a first liquid storage in the edge binder 25. The post-processing apparatus 3 includes a liquid supply path 45, a liquid pump 46 as a liquid supplier, a second liquid storage tank 47 as a part of the second liquid storage, and a second-liquid-storage-tank fixer 61 as a configuration for replenishing the first liquid storage tank 44 with liquid. The liquid that is stored in the second liquid storage tank 47 (referred to as “liquid in the second liquid storage tank 47”) is supplied to the first liquid storage tank 44 through the second-liquid-storage-tank fixer 61, the liquid pump 46, and the liquid supply path 45.

### Configuration of Edge Binder

FIG. 3 is a schematic view of the edge binder 25 viewed from the upstream side in the conveyance direction.

The edge binder 25 performs the liquid application process and the crimp binding process illustrated in FIG. 2.

FIG. 4 is a schematic view of the edge binder 25 viewed from a liquid applier 31 in the main scanning direction.

As illustrated in FIG. 3, the edge binder 25 includes the liquid applier 31 that applies liquid to the sheet P or the sheet bundle Pb, and a crimper 32 that is an example of a post-processing device and performs crimp binding on the sheet bundle Pb. The liquid applier 31 and the crimper 32 are disposed downstream from the internal tray 22 in the conveyance direction and adjacent to each other in the main scanning direction.

As illustrated in FIG. 4, the liquid applier 31 applies the liquid stored in the first liquid storage tank 44 (referred to as “liquid in the first liquid storage tank 44”) to the sheet P or the sheet bundle Pb placed on the internal tray 22. The application of the liquid to the sheet P or the sheet bundle Pb by the liquid applier 31 and the operation of the liquid applier 31 in applying the liquid are referred to as “liquid application” below. The liquid applying operation of the liquid applier 31 involving control processing is referred to as a “liquid application process”.

The liquid that is stored in the first liquid storage tank 44 as liquid for the “liquid application” includes, as a main component, the liquid state of a compound of hydrogen and oxygen represented by the chemical formula H₂O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid may include an additive in addition to the main component. The liquid that is stored in the liquid storage tank may include residual chlorine used as tap water. Preferably, for example, the liquid that is stored in the liquid storage tank may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

As illustrated in FIGS. 3 and 4, the liquid applier 31 is movable in the main scanning direction together with the crimper 32 by a driving force transmitted from an edge binder movement motor 55. The liquid applier 31 includes a lower pressure plate 33 serving as a receptacle for the sheet P or the sheet bundle Pb, an upper pressure plate 34, and a liquid applier movement assembly 35. For example, the lower pressure plate 33, the upper pressure plate 34, the liquid applier movement assembly 35, and a liquid applier movement motor 42 as components of the liquid applier 31 are held by at least one of a liquid application frame 31a and a base 48.

A liquid applier shaft 562 including a drive transmission gear 562a is fixed to a bottom face of the liquid application frame 31a that holds the components of the liquid applier 31. The liquid applier shaft 562 and the drive transmission gear 562a are held by the base 48 on which the liquid application frame 31a is disposed, so as to be rotatable in the forward and reverse directions. The drive transmission gear 562a meshes with an output gear 563a of a liquid applier pivot motor 563. The liquid applier 31 can be rotated in the forward and reverse directions about the liquid applier shaft 562 on the base 48 by a driving force transmitted from the liquid applier pivot motor 563 to the liquid applier shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, the lower pressure plate 33 and the upper pressure plate 34 are arranged to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction”.

Further, a through hole 34a penetrating in the thickness direction is formed in the upper pressure plate 34. The through hole 34a is provided at a position facing the liquid application member 501 held via a holder 37 attached to the base plate 40. As described below, the liquid application member 501 is provided at a first end of the liquid supply member 50 as a liquid absorber. The liquid application member 501 applies the liquid to the sheet P or the sheet bundle Pb by coming into contact with the sheet P or the sheet bundle Pb through the through hole 34a. The liquid application member 501 is the first end of the liquid supply member 50 as a liquid absorber and corresponds to a tip portion of the liquid supply member 50. Details of the liquid supply member 50 will be described below.

The liquid applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid applier movement assembly 35 according to the embodiment moves the upper pressure plate 34, the base plate 40, the holder 37, the liquid application member 501, the liquid supply member 50, and the first liquid storage tank 44 together by the single liquid applier movement motor 42. The liquid applier movement assembly 35 includes, for example, a liquid applier movement motor 42, a trapezoidal screw 38, a nut 39, the base plate 40, columns 41a and 41b, and coil springs 42a and 42b.

The liquid applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 42 via, for example, a pulley and a belt. The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

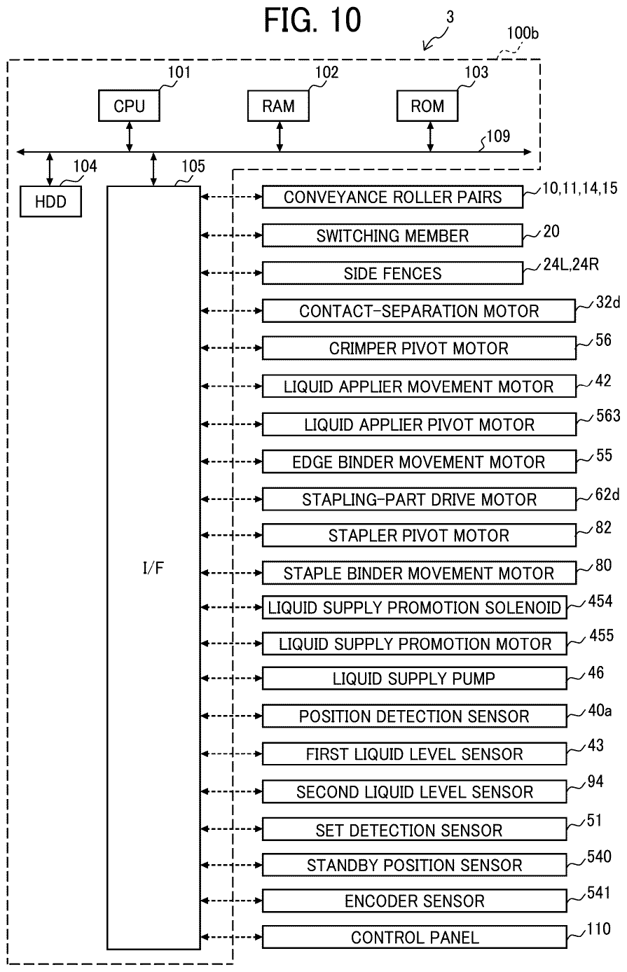

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 10).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers for preventing the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. More particularly, the liquid applier 31 brings the liquid application member 501 into contact with the sheet P or the sheet bundle Pb to apply the liquid to at least one sheet P of the sheet bundle Pb.

The liquid applier 31 includes a first liquid level sensor 43 as a first liquid detector, the first liquid storage tank 44, the liquid application member 501, the liquid supply member 50, and the holder 37. The first liquid storage tank 44 stores the liquid for performing liquid application on the sheet P or the sheet bundle Pb. The liquid level in the first liquid storage tank 44, that is, the amount of liquid stored in the first liquid storage tank 44 is detected by the first liquid level sensor 43. The first liquid storage tank 44 is coupled to the base plate 40 via the holder 37.

The liquid application member 501 applies the liquid in the first liquid storage tank 44 to the sheet P or the sheet bundle Pb. The liquid application member 501, the liquid supply member 50 as a liquid absorber disposed in close contact with the liquid application member 501, and the first liquid storage tank 44 are held by the holder 37. The holder 37 is held by the base plate 40. The liquid supply member 50 has a first end in close contact with the liquid application member 501 and a second end immersed in the liquid in the first liquid storage tank 44. In other words, the second end of the liquid supply member 50 corresponds to an immersion portion 502 that draws up the liquid and supplies the liquid to the liquid application member 501. The liquid application member 501 and the liquid supply member 50 are made of a material having a high liquid absorption rate (for example, sponge or fiber), such as an elastic resin formed of open cells. However, at least one of the liquid application member 501 or the liquid supply member 50 is not limited to a particular kind as long as the at least one of the liquid application member 501 or the liquid supply member 50 is made of a material having a property of absorbing and holding the liquid and has a property of being crushable in accordance with a pressing force applied when the at least one of the liquid application member 501 or the liquid supply member 50 is in contact with the sheet P or the sheet bundle Pb. In other words, the material may be any material as long as the material can absorb or draw up liquid by capillary action.

Accordingly, when the immersion portion 502 of the liquid supply member 50 is immersed in the liquid in the first liquid storage tank 44, the liquid supply member 50 sucks up the liquid by capillary action. In other words, the liquid in the first liquid storage tank 44 is sucked up from the immersion portion 502 of the liquid supply member 50, and the sucked liquid is supplied to the liquid application member 501 that is coupled to the tip portion via the liquid supply member 50. Then, the liquid in the first liquid storage tank 44 is sucked up by the liquid application member 501 in close contact with the first end of the liquid supply member 50, and thus the liquid level of the liquid in the first liquid storage tank 44 decreases. Then, the liquid level of the liquid in the first liquid storage tank 44 detected by the first liquid level sensor 43 decreases. When the first liquid level sensor 43 detects a decrease in the liquid level of the liquid in the first liquid storage tank 44, the supply of the liquid from the second liquid storage tank 47 to the first liquid storage tank 44 by the liquid pump 46 is started. The operation of supplying liquid from the second liquid storage tank 47 to the first liquid storage tank 44 by the liquid pump 46 is referred to as a “liquid supply operation”.

Although the case where the liquid supply member 50 and the liquid application member 501 are separate bodies has been described above, the liquid supply member 50 and the liquid application member 501 may be integrally formed of a material having the same properties (for example, a material having a high liquid absorption rate). In other words, the liquid application member 501 may be part of the liquid supply member 50. In such a case, liquid can be supplied from the liquid supply member 50 to the liquid application member 501 more smoothly by capillary action and a reduction in cost can be achieved.

At this time, the liquid application member 501 draws up the liquid in the first liquid storage tank 44. Accordingly, the liquid level of the liquid in the first liquid storage tank 44 temporarily decreases to a level below the reference liquid level described below. In response to this decrease of liquid in the first liquid storage tank 44, a liquid supply operation for feeding liquid from the second liquid storage tank 47 to the first liquid storage tank 44 is performed. This liquid supply operation is typically performed at the time of activation of the post-processing apparatus 3 or at the time of start of execution of the binding process involving liquid application in the post-processing apparatus 3, and corresponds to the liquid supply operation for bringing the liquid application using the liquid application member 501 to be executable.

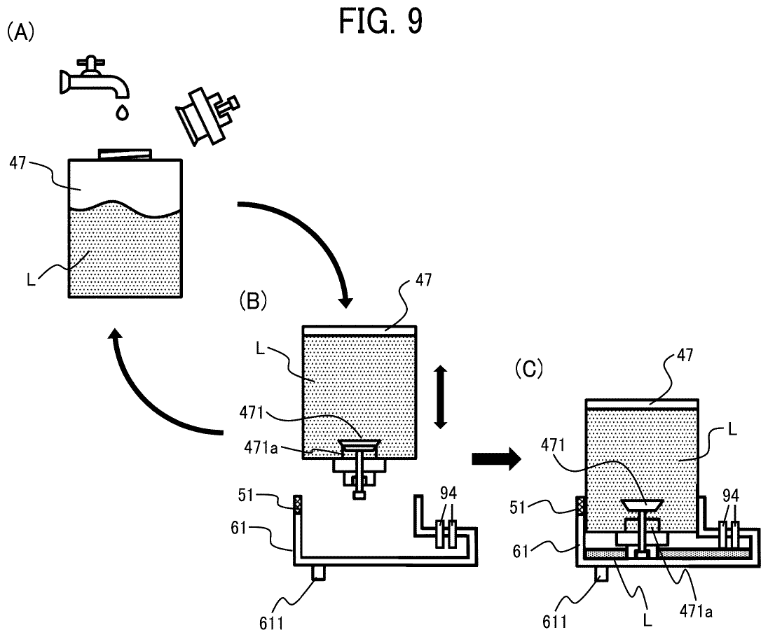

The edge binder 25 or the post-processing apparatus 3 is provided with the second liquid storage tank 47. The second liquid storage tank 47 is attachable to and detachable from the second-liquid-storage-tank fixer 61 as a part of the second liquid storage provided in the edge binder 25 or the post-processing apparatus 3 (see FIG. 9(A), 9(B) and 9(C)). The second-liquid-storage-tank fixer 61 may be provided in either the edge binder 25 or the post-processing apparatus 3. The second liquid storage tank 47 is set in a predetermined posture in the second-liquid-storage-tank fixer 61, so that the liquid in the second liquid storage tank 47 can be supplied to the first liquid storage tank 44 via the second-liquid-storage-tank fixer 61.

The operation to supply liquid from the second liquid storage tank 47 to the first liquid storage tank 44 by the liquid pump 46 is executed in response to a decrease in the reference liquid level in the first liquid storage tank 44. The liquid level in the first liquid storage tank 44 is reduced by the liquid being consumed by the liquid application by the liquid applier 31. In other words, the operation of supplying liquid from the second liquid storage tank 47 to the first liquid storage tank 44 corresponds to the liquid supply operation needed with the execution of the binding process including the liquid application by the liquid applier 31.

This liquid supply operation corresponds to an operation of supplying liquid to the first liquid storage tank 44 so as to add liquid each time the liquid level of the liquid in the first liquid storage tank 44 falls below the reference liquid level, which is described below.

When the second liquid storage tank 47 is set in the second-liquid-storage-tank fixer 61, the second-liquid-storage-tank fixer 61 is filled with a certain amount of the liquid in the second liquid storage tank 47. The second-liquid-storage-tank fixer 61 includes a set detection sensor 51 as a set detector for detecting a set state of the second liquid storage tank 47 (see FIG. 9(B)). When the set detection sensor 51 detects the set state of the second liquid storage tank 47 to the second-liquid-storage-tank fixer 61 (see FIG. 9(C)), a signal indicating that the second liquid storage tank 47 is set on the second-liquid-storage-tank fixer 61 is transmitted to the controller 100b, which is described below. Thus, the controller 100b detects whether the second liquid storage tank 47 is set on the second-liquid-storage-tank fixer 61 based on a signal received from the set detection sensor 51. Details of the second liquid storage tank 47 are described below.

The first liquid storage tank 44 and the second liquid storage tank 47 are connected to each other by the liquid supply path 45. The liquid pump 46 is disposed near the second-liquid-storage-tank fixer 61. As the liquid pump 46 is driven, the liquid in the second liquid storage tank 47 is supplied from the second liquid storage tank 47 to the first liquid storage tank 44 via the liquid supply path 45. Accordingly, the second-liquid-storage-tank fixer 61 is a component of the liquid supplier that executes a liquid supply operation to supply liquid from the second liquid storage tank 47 to the first liquid storage tank 44. The liquid supply path 45 includes a flexible material. According to such a configuration, even if the first liquid storage tank 44 is moved by the liquid applier movement assembly 35, liquid can be supplied from the second liquid storage tank 47 to the first liquid storage tank 44.

The amount of liquid supplied from the second liquid storage tank 47 to the first liquid storage tank 44 can be controlled in accordance with the detection result of the first liquid level sensor 43. In other words, the controller 100b, which is described below, determines the liquid level of the liquid in the first liquid storage tank 44 based on the detection result of the first liquid level sensor 43. In accordance with the determined liquid level of the first liquid storage tank 44, the controller 100b controls the operation speed and time of the liquid pump 46. Thus, the controller 100b can adjust the amount of liquid to be supplied from the second liquid storage tank 47 to the first liquid storage tank 44 to maintain the liquid level of the liquid in the first liquid storage tank 44 at a constant liquid level.

### Configuration of Crimper

As illustrated in FIG. 3, the crimper 32 as a post-processing device included in the edge binder 25 presses and deforms at least a portion, that is, a liquid application position of the sheet bundle Pb, to which liquid has been applied by the liquid applier 31, by serrated upper crimping teeth 32a and lower crimping teeth 32b, and crimps the sheets P of the portion to bind the sheet bundle Pb. In other words, the crimper 32 can bind the sheet bundle Pb without staples. The upper crimping teeth 32a and the lower crimping teeth 32b as components of the crimper 32 are disposed on a crimping frame 32c. Binding by pressing and deforming a given position of the sheet bundle Pb by the crimper 32 will be simply referred to as “crimp binding”. The crimping and binding operation of the crimper 32 that involves control processing is referred to as a “crimp binding process”.

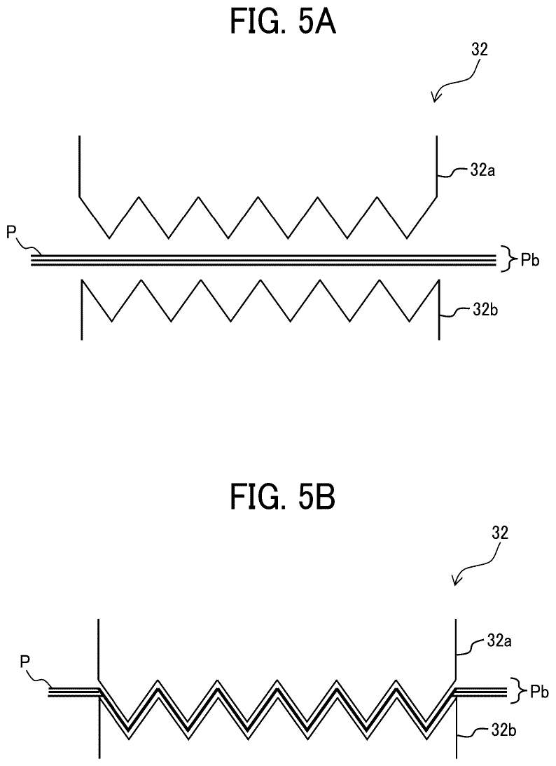

FIGS. 5A and 5B are schematic diagrams illustrating the configuration of the crimper 32.

As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to pinch the sheet bundle Pb placed on the internal tray 22. The upper crimping teeth 32a and the lower crimping teeth 32b have respective serrated faces facing each other. The serrated face of each of the upper crimping teeth 32a and the lower crimping teeth 32b includes concave portions and convex portions alternately formed. The upper crimping teeth 32a and the lower crimping teeth 32b are formed in such a positional relationship that the concave portion and the convex portion are displaced so as to mesh with each other. The upper crimping teeth 32a and the lower crimping teeth 32b are brought into contact with and separated from each other by the driving force of a contact-separation motor 32d illustrated in FIG. 10.

In the process of stacking the sheets P of the sheet bundle Pb to the internal tray 22, the upper crimping teeth 32a and the lower crimping teeth 32b are separated from each other as illustrated in FIG. 5A. When the multiple sheets P of the sheet bundle Pb is all stacked on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. Thus, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of a moving assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (for example, the configuration disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57. The edge binder movement assembly 57 moves the edge binder 25, that is, the liquid applier 31 and the crimper 32 in the main scanning direction along the downstream end of the sheet P, which is placed on the internal tray 22, in the conveyance direction. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 10).

The liquid applier 31 and the crimper 32 are attached to the base 48 such that the liquid applier 31 and the crimper 32 are adjacent to each other in the main scanning direction. As illustrated in FIGS. 3 and 4, the guide shaft 49 is disposed in the main scanning direction on the upstream side of a binding assembly base 116 in the conveyance direction and is held by multiple guide shaft brackets 49a and 49b. As illustrated in FIG. 3, the guide shaft 49 is disposed to extend in the main scanning direction on the binding assembly base 116, and holds the base 48 to be movable in the main scanning direction. As illustrated in FIG. 4, the guide rail 115 is disposed in the downstream side of the binding assembly base 116 in the conveyance direction and extends in the main scanning direction. As illustrated in FIG. 4, the guide rail 115 has a to-be-fitted portion 115a that fits a scanning roller 48a, which is rotatably disposed on the base 48, across the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. Thus, the liquid applier 31 and the crimper 32 integrated by the base 48 move in the main scanning direction along the guide shaft 49.

The edge binder movement motor 55 according to the present embodiment is, for example, a servomotor. By using the servomotor, the edge binder 25 can be stopped at any target position without returning the edge binder 25 to the origin position every time the movement is performed. That is, the edge binder movement motor 55 can stop the edge binder 25 at the target position, that is, a first liquid application position B1, a first binding position B1, a second liquid application position B2, and a second binding position B2 to be described below without returning the edge binder 25 to the origin position (for example, a standby position HP to be described below) every movement.

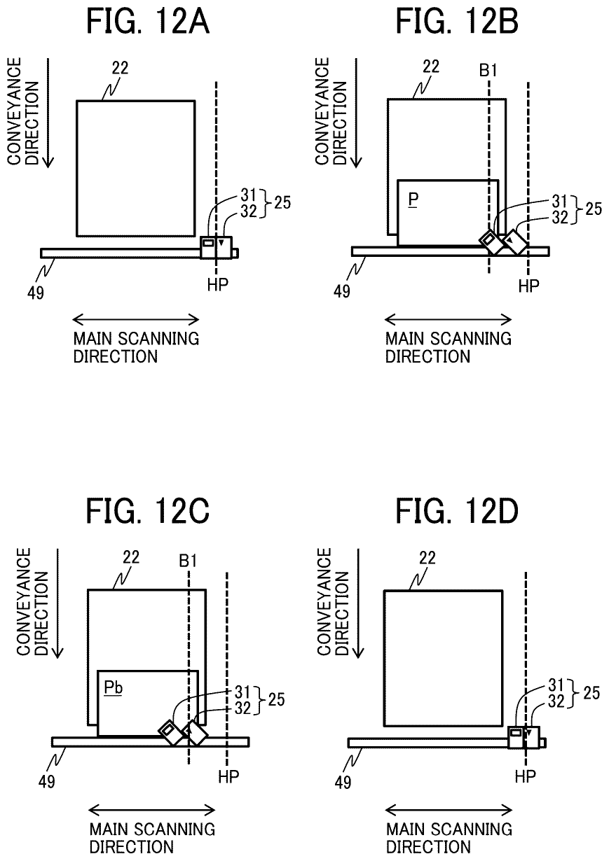

The post-processing apparatus 3 further includes a standby position sensor 540 and an encoder sensor 541. The standby position sensor 540 (see FIG. 10) detects that the edge binder 25 has reached the standby position HP (FIG. 12A). The encoder sensor 541 (see FIG. 10) is attached to an output shaft of the edge binder movement motor 55. The standby position sensor 540 is, for example, a light shielding type optical sensor. The controller 100b, which will be described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by the base 48 on which the crimping frame 32c is disposed, so as to be rotatable in the forward and reverse directions. The drive transmission gear 54a meshes with an output gear 56a of a crimper pivot motor 56. The crimper 32 is rotatable in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

### Configuration of Staple Binder

Specifically, a detailed description is now given of the staple binder 155 having a function of executing a stapling process.

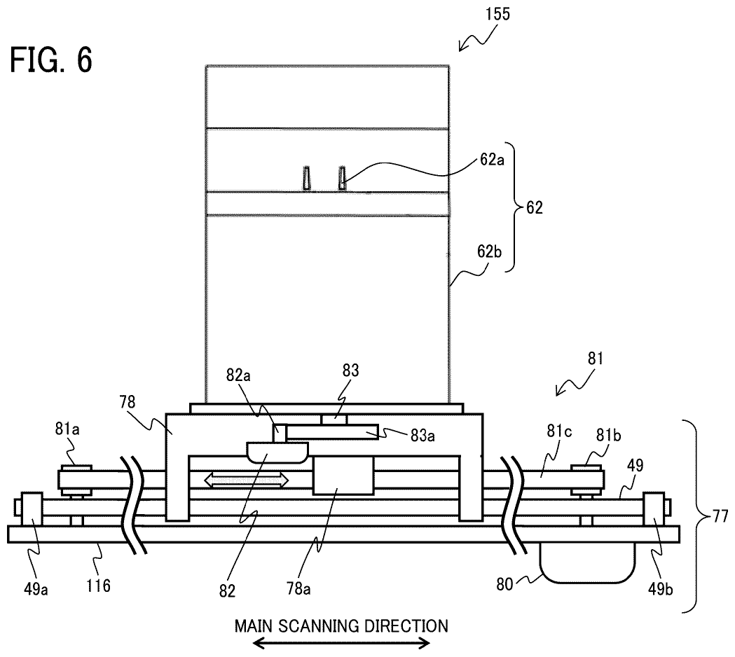

FIG. 6 is a schematic view of the staple binder 155 viewed from the upstream side in the conveyance direction.

The staple binder 155 includes a stapler 62 that binds the sheet bundle Pb with staples. The stapler 62 is disposed downstream from the internal tray 22 in the conveyance direction and spaced apart from the edge binder 25 in the main scanning direction.

The stapler 62 serving as a post-processing device has a configuration of performing so-called “stapling process” to bind the sheet bundle Pb with a staple. More particularly, the stapler 62 includes a stapling-part drive motor 62d illustrated in FIG. 10. The stapling-part drive motor 62d drives a stapling part 62a. The driving force of the stapling-part drive motor 62d causes a staple loaded in the stapling part 62a to insert through a sheet bundle Pb, so that the stapling part 62a binds the sheet bundle Pb. Since the stapler 62 has a typical configuration, a detailed description thereof will be omitted unless otherwise required.

As illustrated in FIG. 6, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler shaft 83 including a drive transmission gear 83a is fixed to a bottom face of a stapling frame 62b that holds the components of the stapler 62.

The stapler shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 can be rotated in the forward and reverse directions about the stapler shaft 83 on the base 78 by a driving force transmitted from the stapler pivot motor 82 to the stapler shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can independently move the edge binder 25 and the staple binder 155.

### Configuration of Modification of Staple Binder

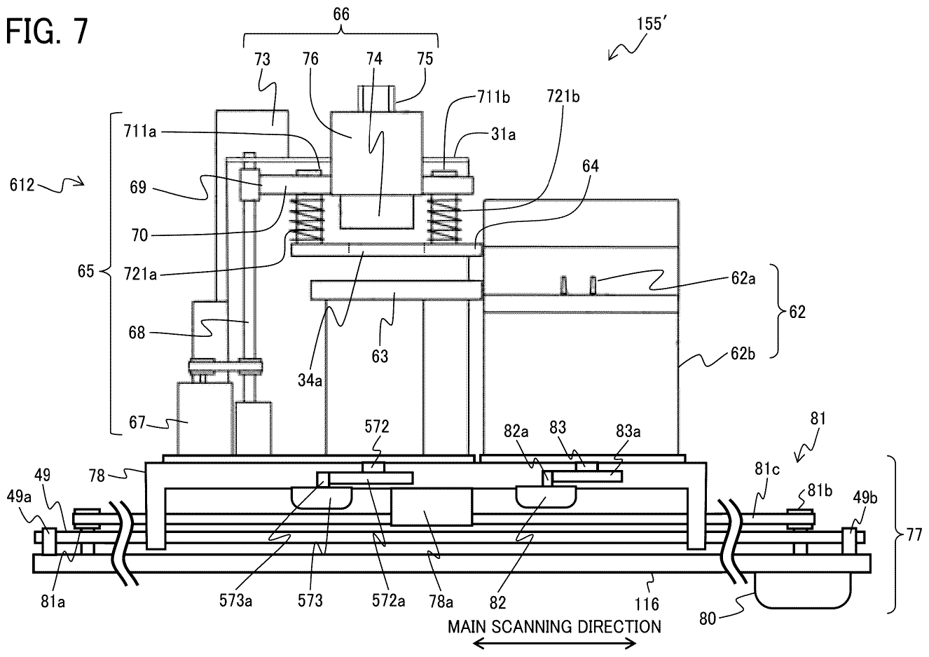

FIG. 7 illustrates a staple binder 155′ as a modification of the staple binder 155. More specifically, FIG. 7 is a schematic view of the staple binder 155′ viewed from the upstream side in the conveyance direction.

The staple binder 155′ is different from the staple binder 155 in that the staple binder 155′ includes a second liquid applier 612 in addition to the stapler 62. As illustrated in FIG. 7, the staple binder 155′ includes the second liquid applier 612 and the stapler 62. The second liquid applier 612 and the stapler 62 are disposed downstream from the internal tray 22 in the conveyance direction and adjacent to each other in the main scanning direction.

The second liquid applier 612 performs the liquid application of applying liquid stored in a third liquid storage tank 73 to the sheet P or the sheet bundle Pb placed on the internal tray 22. A given area including a position to which the liquid application is performed on the sheet P or the sheet bundle Pb by the second liquid applier 612 corresponds to a binding position to be stapled by the stapler 62. As illustrated in FIG. 7, the second liquid applier 612 includes a second lower pressure plate 63, a second upper pressure plate 64, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second column members 711a and 711b, and second coil springs 721a and 721b.

The second liquid application assembly 66 includes a third liquid storage tank 73, a second liquid supply member 75, a second liquid application member 74, and a second holder 76. Since the second liquid application assembly 66 and the liquid application assembly of the liquid applier 31 including the first liquid storage tank 44, the liquid supply member 50, the liquid application member 501, and the holder 37 described with reference to FIGS. 3 and 4 have common configurations, redundant descriptions thereof will be omitted. Since the stapler 62 has a configuration similar to the configuration of the staple binder 155 illustrated in FIG. 6, a detailed description thereof is omitted below unless otherwise required. Since the pivot mechanism of the second liquid applier 612 including the second liquid applier pivot motor 573, the second output gear 573a, the second drive transmission gear 572a, and the second liquid applier shaft 572 and the pivot mechanism of the liquid applier 31 including the liquid applier pivot motor 563, the output gear 563a, the drive transmission gear 562a, and the liquid applier shaft 562 illustrated in FIG. 3 have common configurations, redundant descriptions thereof will be omitted.

As with the staple binder 155′ illustrated in FIG. 7, when the liquid application is also performed on the sheet P in the stapling process, the binding position is loosened and softened, thus allowing the staple to easily pass through. As a result, the number of sheets to be bound per sheet bundle Pb can be increased as compared with a case where the stapling process is performed without applying the liquid.

### Configuration of Second Liquid Storage Tank

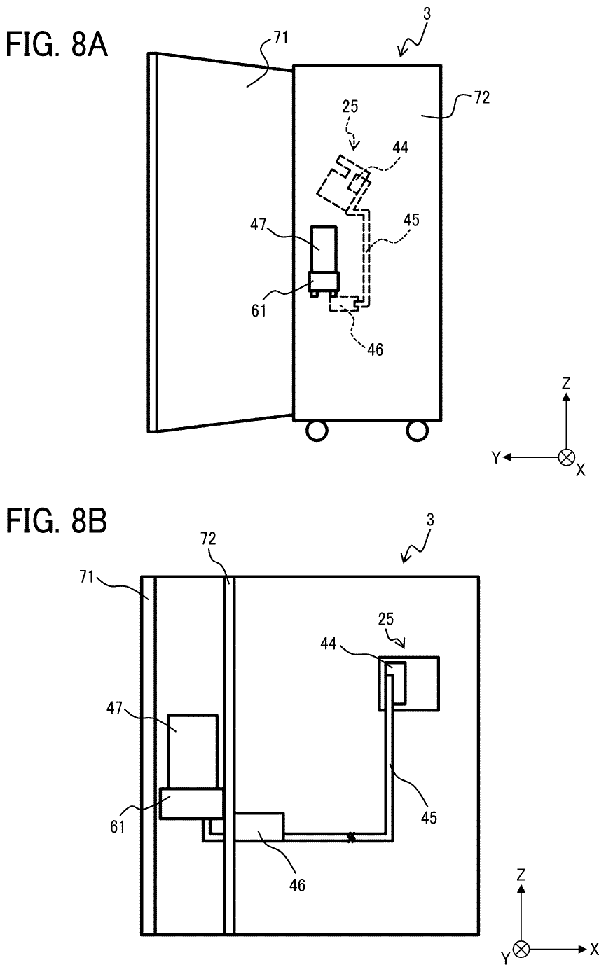

With reference to FIGS. 8A, 8B, and 9 including FIG. 9(A), 9(B) and 9(C), a description is given of the arrangement and configuration of the second liquid storage tank 47 in the post-processing apparatus 3.

FIGS. 8A and 8B are views illustrating a location and configuration of the second liquid storage tank 47 as the main tank in the post-processing apparatus 3.

FIG. 8A illustrates a state where an opening/closing cover 71 constituting part of an apparatus housing of the post-processing apparatus 3 is opened.

FIG. 8B is a cross-sectional side view of the post-processing apparatus 3, illustrating a state where the opening/closing cover 71 of the post-processing apparatus 3 is closed.

As illustrated in FIG. 8A, the second liquid storage tank 47 is located so as to be accessible when the opening/closing cover 71 of the post-processing apparatus 3 is opened. As illustrated in FIG. 8B, the second liquid storage tank 47 and the second-liquid-storage-tank fixer 61 are disposed on the near side in a depth direction (X direction) of the post-processing apparatus 3. The first liquid storage tank 44, for example, is disposed on the far side in the depth direction (X direction) of the post-processing apparatus 3. A housing side plate 72 of the post-processing apparatus 3 is disposed between the location of the second liquid storage tank 47 and the second-liquid-storage-tank fixer 61 and the location of the first liquid storage tank 44 and so forth. The second-liquid-storage-tank fixer 61 is attached to the housing side plate 72 of the post-processing apparatus 3.

FIG. 9 including 9(A), 9(B) and 9(C) is a diagram illustrating a configuration of attachment and detachment of the second liquid storage tank 47 in the post-processing apparatus 3.

FIG. 9 including 9(A), 9(B) and 9(C) illustrates a state in which the second liquid storage tank 47 is attachable to and detachable from the second-liquid-storage-tank fixer 61 and a state in which liquid is replenished to the second liquid storage tank 47.

As illustrated in FIG. 9(A), the second liquid storage tank 47 is attachable to and detachable from the second-liquid-storage-tank fixer 61 so that liquid can be replenished to the first liquid storage tank 44. As illustrated in FIG. 9(B), the second-liquid-storage-tank fixer 61 includes the set detection sensor 51 that detects that the second liquid storage tank 47 is set on the second-liquid-storage-tank fixer 61.

When the set detection sensor 51 detects the set state of the second liquid storage tank 47 to the second-liquid-storage-tank fixer 61 (see FIG. 9(C)), a signal indicating the set state is transmitted to the controller 100b, which will be described below. Thus, the controller 100b determines whether the second liquid storage tank 47 is set on the second-liquid-storage-tank fixer 61.

The second-liquid-storage-tank fixer 61 includes a second liquid level sensor 94 as a second liquid detector for detecting the level of the liquid L stored in the second-liquid-storage-tank fixer 61 (referred to as “liquid L in the second-liquid-storage-tank fixer 61”). The output value of the second liquid level sensor 94 is notified to the controller 100b, which will be described below. The controller 100b determines the output value of the second liquid level sensor 94 to determine whether the level of the liquid L in the second-liquid-storage-tank fixer 61 is a necessary liquid level, that is, whether the amount of liquid stored in the second-liquid-storage-tank fixer 61 is a necessary liquid amount. When determining that the second liquid storage tank 47 is in the set state according to the output signal of the set detection sensor 51, the controller 100b described below turns on the energization of the second liquid level sensor 94. Thus, the second liquid level sensor 94 can detect the level of the liquid L in the second-liquid-storage-tank fixer 61, that is, the presence or absence of the liquid L in the second-liquid-storage-tank fixer 61.

When the second liquid storage tank 47 is not set on the second-liquid-storage-tank fixer 61, a liquid discharge port 471a of the second liquid storage tank 47 is closed by a liquid supply valve 471 so that the liquid L does not leak. As illustrated in FIG. 9(C), when the second liquid storage tank 47 is set on the second-liquid-storage-tank fixer 61, the liquid supply valve 471 is pushed up to open the liquid discharge port 471a of the second liquid storage tank 47. As a result, the liquid L in the second liquid storage tank 47 flows out to the second-liquid-storage-tank fixer 61. The liquid L that has flowed out from the second liquid storage tank 47 is stored in the second-liquid-storage-tank fixer 61.

As a measure to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid supply path 45 is conveyed by the liquid pump 46 to the second-liquid-storage-tank fixer 61 via the liquid supply path 45 in the reverse direction. For that purpose, the second-liquid-storage-tank fixer 61 is set to the capacity that can sufficiently store the liquid L in the first liquid storage tank 44 and the liquid supply path 45. As illustrated in FIG. 9(B) and 9(C), the second-liquid-storage-tank fixer 61 is provided with a liquid drain plug 611. In the liquid draining process, the liquid L remaining in the first liquid storage tank 44 and the liquid supply path 45 is conveyed by the liquid pump 46 to the second-liquid-storage-tank fixer 61 in the reverse direction. Thereafter, the liquid drain plug 611 is opened. By opening the liquid drain plug 611, the liquid L stored in the second-liquid-storage-tank fixer 61 can be discharged to the outside of the post-processing apparatus 3.

### Configuration of Control Block of Post-Processing Apparatus

A description is given below of control blocks of the post-processing apparatus 3 with reference to FIG. 10.

FIG. 10 is a hardware configuration diagram of a control block of the post-processing apparatus 3 according to the first embodiment.

As illustrated in FIG. 10, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute a controller 100b serving as a control device that controls the operation of the post-processing apparatus 3.

The I/F 105 is an interface that connects the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid pump 46, a liquid supply promotion solenoid 454, a liquid supply promotion motor 455, the movement sensor 40a, the first liquid level sensor 43, the second liquid level sensor 94, the set detection sensor 51, the standby position sensor 540, the encoder sensor 541, and a control panel 110 to the common bus 109.

The controller 100b controls, via the I/F 105, the operations of the conveyance roller pairs 10, 11, 14, and 15, the switching member 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid pump 46, the liquid supply promotion solenoid 454, and the liquid supply promotion motor 455. The controller 100b acquires detection results from the movement sensor 40a, the first liquid level sensor 43, the second liquid level sensor 94, the set detection sensor 51, the standby position sensor 540, and the encoder sensor 541. Although FIG. 10 illustrates only the components related to the edge binder 25 and the staple binder 155 that perform the edge binding process, the components related to the saddle binder 28 that performs the saddle binding are also controlled by the controller 100b.

As illustrated in FIG. 1, the image forming apparatus 2 includes the control panel 110. The control panel 110 includes an operation unit that receives instructions from a user and a display serving as a notifier that notifies the user of information. The operation unit includes, for example, physical input buttons and a touch panel overlaid on a display. The control panel 110 acquires information from the user through the operation unit and provides the information to the user through the display. A specific example of the notifier is not limited to the display and may be a light-emitting diode (LED) lamp or a speaker. The post-processing apparatus 3 may include a control panel 110 similar to the above-described control panel 110 of the image forming apparatus 2.

As described above, the post-processing apparatus 3 implements the function of performing operation control related to the liquid application by software, that is, control programs executed by the CPU 101 with hardware resources included in the controller 100b.

In some embodiments, the liquid application performed by the post-processing apparatus 3 may be performed in a form in which the staple binder 155 is provided with only the stapler 62 and the liquid application is performed using the liquid applier 31 of the edge binder 25. By contrast, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration of moving along the guide shaft 49 with the stapler 62 and the second liquid applier 612 being integrated, and the embodiments of the present disclosure are not limited to the above-described configuration. For example, the stapler 62 and the second liquid applier 612 may have a configuration of moving separately from each other.

### Description of Binding Process

A description is given below of the binding process executed by the edge binder 25 included in the post-processing apparatus 3.

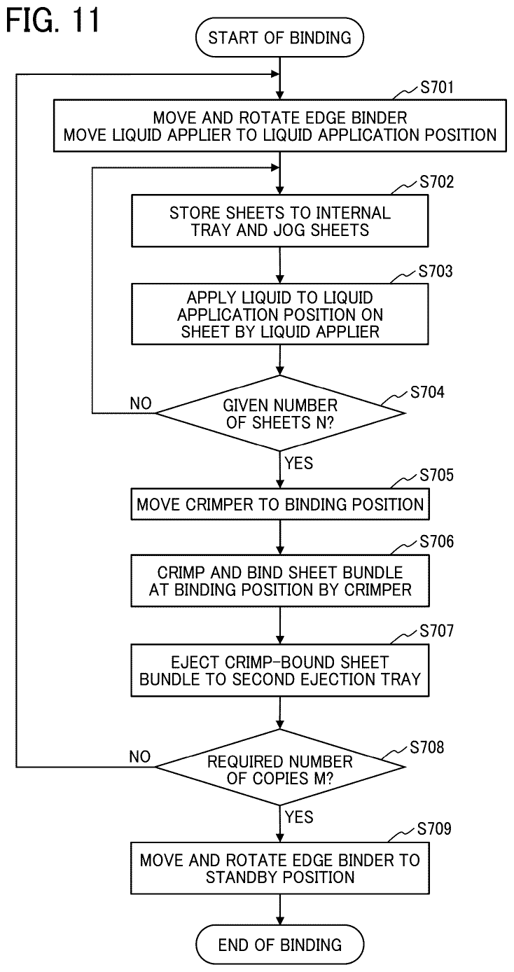

FIG. 11 is a flowchart of a one-point binding process executed by the edge binder 25.

FIGS. 12A, 12B, 12C and 12D are diagrams illustrating the position shift of the edge binder 25 including the liquid applier 31 and the crimper 32 during the one-point binding process.

In FIGS. 12A, 12B, 12C and 12D, the changes in the postures of the liquid applier 31 and the crimper 32 are omitted. The position at which liquid application is executed (referred to as a “liquid application position”) on the sheet P or the sheet bundle Pb by the liquid applier 31 corresponds to the binding position on the sheet bundle Pb to be crimped and bound by the crimper 32. For this reason, in the following description, the liquid application position and the binding position are denoted by the same reference numeral (B1 and B2).

For example, the controller 100b starts the binding process illustrated in FIG. 11 when the controller 100b acquires an instruction to execute the binding process from the image forming apparatus 2. In the following description, the instruction to execute the binding process may be referred to as a “binding command”.

The binding command includes, for example, information related to the type of sheets P, the number of sheets P constituting the sheet bundle Pb, the number of copies of the sheet bundle Pb to be subjected to, for example, the binding process, the binding position of the sheet bundle Pb, and the binding posture of the edge binder 25. The information regarding the type of the sheet P includes information that affects the spread of the liquid, such as a material and a thickness. In the following description, the number of sheets P constituting the sheet bundle Pb is referred to as a “predetermined number N”. The number of copies of the sheet bundle Pb to be subjected to the binding process is referred to as a “required number of copies M”. The liquid applier 31 and the crimper 32 are assumed to be in a parallel binding posture and located at a standby position HP that is a position away in the main scanning direction from the sheets P placed on the internal tray 22 at the start of the binding process as illustrated in FIG. 12A.

When the posture that is instructed by the binding command is the “oblique binding posture”, the controller 100b drives the liquid applier pivot motor 563 and the crimper pivot motor 56 to rotate the liquid applier 31 and the crimper 32 included in the edge binder 25 into the oblique binding posture (step S701). When the posture is the “oblique binding posture”, the crimper 32 alone may be rotated to the oblique binding posture and the liquid applier 31 may be restricted not to rotate in the forward and reverse directions. As a result, the driving assembly may be simplified as compared with a case where both the liquid applier 31 and the crimper 32 are rotated in the forward and reverse directions, and thus effects of cost reduction, downsizing of the apparatus, and reduction of failure of the device are exhibited.

On the other hand, when the posture that is instructed by the binding command is the “parallel binding posture”, the controller 100b omits the aforementioned operation of rotating the liquid applier 31 and the crimper 32 included in the edge binder 25 described above to the oblique binding posture.

The controller 100b drives the edge binder movement motor 55 to move the edge binder 25 in the main scanning direction by the edge binder movement assembly 57 so that the liquid applier 31 faces the first liquid application position B1 instructed by the binding command (step S701). The controller 100b executes the process of step S701 before a first sheet P is conveyed to the internal tray 22 by the conveyance roller pairs 10, 11, 14, and 15.

The controller 100b rotates the conveyance roller pairs 10, 11, 14, and 15 to store the sheet P, on which the image has been formed by the image forming apparatus 2, onto the internal tray 22 (step S702). The controller 100b executes so-called jogging processing of aligning the positions in the main scanning direction of the sheet P or the sheet bundle Pb placed on the internal tray 22 by reciprocating the side fences 24L and 24R as aligners in the main scanning direction (step S702).

The controller 100b causes the liquid applier 31 facing the first liquid application position B1 to apply liquid to the first liquid application position B1 of the sheet P placed on the internal tray 22 in the immediately preceding step S702, based on liquid application control data adjusted in advance (step S703). In other words, the controller 100b drives the liquid applier movement motor 42 to bring the liquid application member 501 into contact with the first liquid application position B1 on the sheet P placed on the internal tray 22 (see FIG. 12B). In the liquid application process in step S703, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid applier movement motor 42 based on the adjusted control data, and adjusts the amount of movement of the liquid application member 501 with respect to the first liquid application position B1 of the sheet P placed on the internal tray 22.

The controller 100b determines whether the number of sheets P placed on the internal tray 22 has reached the given number of sheets N instructed by the binding command (step S704). When the controller 100b determines that the number of sheets P placed on the internal tray 22 has not reached the given number of sheets N (No in step S704), the controller 100b executes the operations of steps S702 to S704 again until the number of sheets P placed on the internal tray 22 reaches the given number of sheets N (Yes in step S704). In other words, the controller 100b executes the processing of steps S702 to S704 each time the sheet P is conveyed to the internal tray 22 by the conveyance roller pairs 10, 11, 14, and 15. The liquid application by the liquid applier 31 may be performed not only on all of the multiple sheets P constituting the sheet bundle Pb, but also on only a part of the multiple sheets P.

When the controller 100b determines that the number of sheets P placed on the internal tray 22 has reached the given number of sheets N (Yes in step S704), the controller 100b drives the edge binder movement motor 55 to move the edge binder 25 in the main scanning direction by the edge binder movement assembly 57 so that the crimper 32 faces the first binding position B1 as illustrated in FIG. 12C (step S705).

The controller 100b causes the crimper 32 to crimp and bind the sheet bundle Pb placed on the internal tray 22 (step S706). The controller 100b causes the conveyance roller pair 15 to eject the sheet bundle Pb thus crimped and bound by the crimper 32 to the second ejection tray 26 (step S707). Specifically, the controller 100b drives the contact-separation motor 32d to cause the upper crimping teeth 32a and the lower crimping teeth 32b to pinch the first binding position B1 on the sheet bundle Pb placed on the internal tray 22. Specifically, the controller 100b drives the contact-separation motor 32d to cause the upper crimping teeth 32a and the lower crimping teeth 32b to pinch the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is placed on the internal tray 22 has a crimping area, in other words, the first binding position B1 sandwiched between the upper crimping teeth 32a and the lower crimping teeth 32b in step S706. The crimping area overlaps a liquid application area, in other words, the first liquid application position B1 contacted by the tip portion of the liquid application member 501 in step S703. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlap the liquid application area contacted by the distal end of the liquid application member 501, and can obtain a sufficient binding strength even in a case where the crimping area partially overlaps the liquid application area.

The controller 100b determines whether the number of sheet bundles Pb thus ejected to the second ejection tray 26 has reached the requested number of copies M indicated by the binding command (step S708). When the controller 100b determines that the number of sheet bundles Pb thus ejected has not reached the requested number of copies M (No in step S708), the controller 100b executes the operations of step S701 and the following steps again. In other words, when the controller 100b determines that the number of sheet bundles Pb thus ejected has reached the requested number of copies M (Yes in step S708), the controller 100b repeats the operations of steps S701 to S708 until the number of sheet bundles Pb ejected to the second ejection tray 26 reaches the requested number of copies M.

On the other hand, when the controller 100b determines that the number of sheet bundles Pb output to the second ejection tray 26 has reached the requested number of copies M (Yes in step S708), the controller 100b drives the edge binder movement motor 55 to move the edge binder 25 including the liquid applier 31 and the crimper 32 to the standby position HP as illustrated in FIG. 12D (step S709). When the posture that is instructed by the binding command is the “inclined binding posture”, the controller 100b drives the liquid applier pivot motor 563 and the crimper pivot motor 56 to rotate the liquid applier 31 and the crimper 32 into the parallel binding posture (step S709). On the other hand, when the posture that is instructed by the binding command is the “parallel binding posture”, the controller 100b skips the aforementioned operation of rotating the liquid applier 31 and the crimper 32 to the parallel binding posture. Thus, the edge binder 25 including the liquid applier 31 and the crimper 32 returns to the standby position HP as illustrated in FIG. 12D. In steps S701 and S709, the order of execution of the operation of moving the edge binder 25 in the main scanning direction by the edge binder movement assembly 57 and the operation of rotating the liquid applier 31 and the crimper 32 in the forward and reverse directions by the liquid applier pivot motor 563 and the crimper pivot motor 56 is not limited to the above-described order, and may be the order opposite to the above-described order.

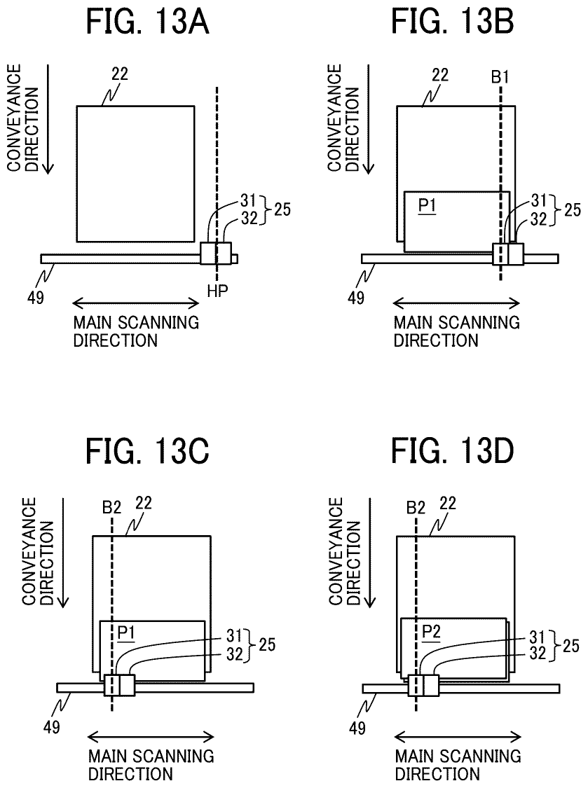

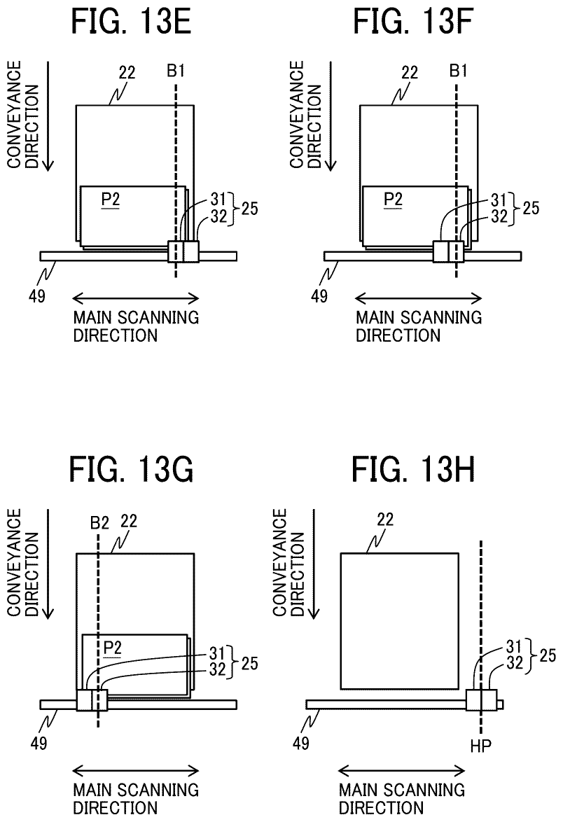

FIGS. 13A, 13B, 13C, 13D, 13E, 13F, 13G and 13H are diagrams illustrating the positions shift of the edge binder 25 during execution of a two-point binding process.

A detailed description of points common to the process described with reference to FIGS. 12A to 13D may be omitted, and differences will be mainly described.

As illustrated in FIG. 13A, it is assumed that the edge binder 25 is located at the standby position HP at the start point of the two-point binding process. The first binding position B1 and the second binding position B2 are apart from each other in the main scanning direction. In FIGS. 13A, 13B, 13C, 13D, 13E, 13F, 13G and 13H, a case where two sheets P1 and P2 are pressure-bonded, in other words, a case where N=2 will be described. In the case of executing the two-point binding process, the number of sheets P included in the sheet bundle Pb is not limited to two, and the two-point binding can be performed on a sheet bundle Pb having the same number of sheets as the number of sheets that can be bound in one-point binding process.

Before a first sheet P1 for a sheet bundle Pb is supplied to the internal tray 22, the controller 100b causes the edge binder 25 to move in the main scanning direction by the edge binder movement assembly 57 such that the liquid applier 31 can face the first liquid application position B1 (see FIG. 13B).

Subsequently, as illustrated in FIG. 13B, the controller 100b places the liquid applier 31 at the position to face the first liquid application position B1. With this state, the sheet P1 on which an image has been formed by the image forming apparatus 2 is placed on the internal tray 22, and the controller 100b executed jogging processing by reciprocating the side fences 24L and 24R in the main scanning direction. In response to the placement of the first sheet P1 on the internal tray 22, the controller 100b causes the liquid applier 31 to apply the liquid to the first liquid application position B1 of the first sheet P1.

Subsequently, as illustrated in FIG. 13C, the controller 100b causes the edge binder 25 to move in the main scanning direction by the edge binder movement assembly 57 such that the liquid applier 31 faces the second liquid application position B2 of the first sheet P1. Then, the controller 100b causes the liquid applier 31 to apply the liquid to the second liquid application position B2 of the first sheet P1.

In response to the application of the liquid to the first liquid application position B1 and the second liquid application position B2 of the first sheet P1, the controller 100b causes a second sheet P2 for the sheet bundle Pb to be placed on the internal tray 22 and executes the jogging processing on the second sheet P2 by reciprocating the side fences 24L and 24R in the main scanning direction in a state where the liquid applier 31 is disposed at a position which the liquid applier 31 can face the second liquid application position B2 as illustrated in FIG. 13D. In response to the placement of the second sheet P2 on the internal tray 22, the controller 100b causes the liquid applier 31 to apply the liquid to the second liquid application position B2 of the second sheet P2.

Then, as illustrated in FIG. 13E, the controller 100b causes the edge binder 25 to move in the main scanning direction by the edge binder movement assembly 57 such that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeatedly execute the conveyance of the sheet P and the liquid application to the first liquid application position B1 and the second liquid application position B2 until the number of sheets P placed on the internal tray 22 reaches the given number of sheets N. At this time, the controller 100b causes the liquid applier 31 to perform the liquid application to the B-th sheet P (B<N) in the order of the first liquid application position B1 and the second liquid application position B2.

The controller 100b also causes the liquid applier 31 to perform the liquid application to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, in response to a determination that the number of sheets P placed on the internal tray 22 has reached the given number of sheets N, the controller 100b causes the edge binder 25 to move in the main scanning direction by the edge binder movement assembly 57 such that the crimper 32 faces the first binding position B1 as illustrated in FIG. 13F. The controller 100b causes the crimper 32 to crimp and bind the first binding position B1 of the sheet bundle Pb including the first sheet P1 and the second sheet P2 placed on the internal tray 22.

Then, as illustrated in FIG. 13G, the controller 100b causes the edge binder 25 to move in the main scanning direction by the edge binder movement assembly 57 such that the crimper 32 faces the second binding position B2 of the sheet bundle Pb. The controller 100b causes the crimper 32 to execute crimping on the second binding position B2 of the sheet bundle Pb placed on the internal tray 22.

In the example illustrated in FIGS. 13A, 13B, 13C, 13D, 13E, 13F, 13G and 13H, since the controller 100b causes the liquid applier 31 to finally apply the liquid to the first liquid application position B1, the controller 100b may cause the crimper 32 to execute the crimp binding in the order of the first binding position B1 and the second binding position B2. On the other hand, in a case where the controller 100b causes the liquid applier 31 to finally apply the liquid to the second liquid application position B2, the controller 100b may cause the crimper 32 to execute the crimp binding in the order of the second binding position B2 and the first binding position B1.

In other words, as illustrated in FIGS. 13A, 13B, 13C, 13D, 13E, 13F, 13G and 13H, the controller 100b causes the edge binder movement assembly 57 to move the edge binder 25 by the shortest distance between the position at which the liquid applier 31 faces the first liquid application position B1 and the position at which the liquid applier 31 faces the second liquid application position B2 without passing through the standby position HP. The controller 100b causes the edge binder movement assembly 57 to move the edge binder 25 by the shortest distance between the position at which the crimper 32 faces the first binding position B1 and the position at which the crimper 32 faces the second binding position B2 without passing through the standby position HP. Further, the controller 100b causes the edge binder movement assembly 57 to move the edge binder 25 by the shortest distance between the position at which the liquid applier 31 faces the first liquid application position B1 (or the second liquid application position B2) and the position at which the crimper 32 faces the first binding position B1 (or the second binding position B2) without passing through the standby position HP. Accordingly, productivity of the crimp binding can be improved.

Then, the controller 100b causes the conveyance roller pair 15 to rotate to eject the sheet bundle Pb to the second ejection tray 26 after the sheet bundle Pb is crimped and bound by the crimper 32 at the first binding position B1 and the second binding position B2. Further, as illustrated in FIG. 13H, the controller 100b drives the edge binder movement motor 55 to move the edge binder 25 (the liquid applier 31 and the crimper 32) to the standby position HP.

Although an example in which one or two positions of the sheet bundle Pb are crimped and bound has been described in the above-described embodiment, an embodiment of the present disclosure is also applicable to a case in which three or more positions of the sheet bundle Pb spaced apart from each other in the main scanning direction are crimped and bound. In this case, the controller 100b causes the liquid applier 31 to apply the liquid to three or more liquid application positions (corresponding to the crimp binding positions) and causes the crimper 32 to perform crimping. According to an embodiment of the present disclosure, the productivity of the crimp binding can be enhanced even when three or more positions are crimped and bound.

However, it is not necessary to apply the liquid to all the liquid application positions (corresponding to crimp binding positions) for all the sheets P included in the sheet bundle Pb. For example, when crimp binding is performed on three crimp binding positions liquid application positions apart from each other in the main scanning direction, the controller 100b may cause the liquid applier 31 to apply the liquid to three liquid application positions (corresponding to crimp binding positions) of an E-th sheet P1 (E<N−2), apply the liquid to two liquid application positions (corresponding to crimp binding positions) of an (E+1)-th sheet P2, and apply the liquid to one liquid application position (corresponding to a crimp binding position) of an (E+2)-th sheet P2.

### Configuration of Liquid Applier

A more detailed description is given of the configuration of the liquid applier 31 of a post-processing apparatus 3 according to an embodiment of the present disclosure.

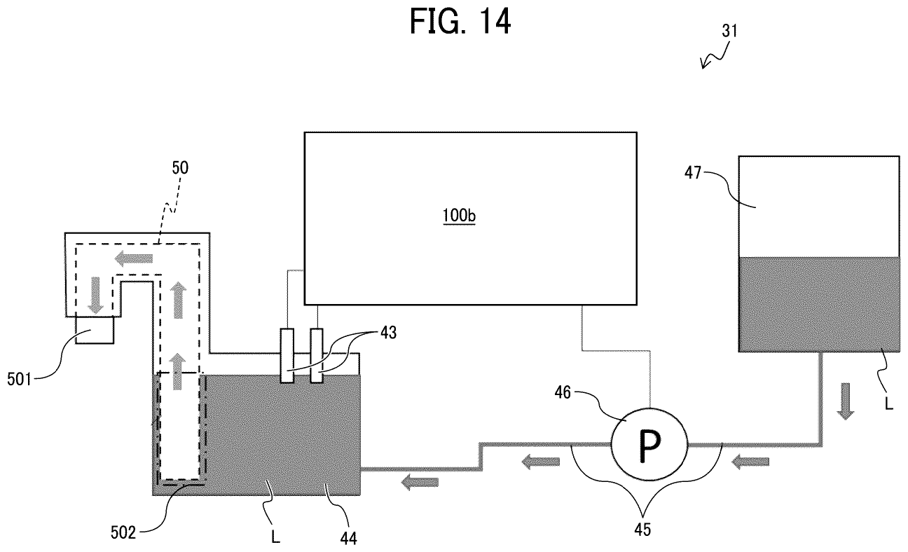

FIG. 14 is a configuration diagram illustrating the liquid applier 31 according to the present embodiment.

The liquid applier 31 includes the liquid supply member 50 including the liquid application member 501 and the immersion portion 502, the first liquid storage tank 44 as a first liquid storage, the second liquid storage tank 47 as a second liquid storage, the liquid supply path 45, the liquid pump 46 as a liquid supplier, and the controller 100b as a control device.

As described above, the liquid supply member 50 is formed of a liquid absorber that has a portion, in other words, the immersion portion 502 to be immersed in the liquid stored in the first liquid storage tank 44 and another portion, in other words, the liquid application member 501 to come into contact with a sheet P or a sheet bundle Pb to perform the liquid application onto the sheet P or the sheet bundle Pb.

The second liquid storage tank 47 stores liquid to be supplied to the first liquid storage tank 44. The liquid stored in the second liquid storage tank 47 is supplied to the first liquid storage tank 44 through the liquid supply path 45 by the operation of the liquid pump 46.

The first liquid storage tank 44 includes the first liquid level sensor 43 as a first liquid detector for detecting the level of the liquid in the first liquid storage tank 44. The first liquid level sensor 43 is an electrode sensor having a pair of electrodes.

The output value (for example, voltage) output when the first liquid level sensor 43 detects the liquid level of the liquid in the first liquid storage tank 44 is input to the controller 100b as a control device. The controller 100b determines the liquid level of the liquid in the first liquid storage tank 44, in other words, the amount of liquid stored in the first liquid storage tank 44 based on whether the input output value exceeds the “liquid detection threshold value” which is a threshold value. When the controller 100b determines that liquid needs to be replenished to the first liquid storage tank 44, the controller 100b operates the liquid pump 46 to supply the liquid from the second liquid storage tank 47 to the first liquid storage tank 44.

The controller 100b controls the timing of application of the voltage to the electrodes of the first liquid level sensor 43. The controller 100b also controls the start and stop of the operation of the liquid pump 46 in accordance with the output value of the first liquid level sensor 43. When the first liquid level sensor 43 detects the liquid (liquid level) in the first liquid storage tank 44 by the operation of the liquid pump 46 according to the output value of the first liquid level sensor 43, the controller 100b stops the operation of the liquid pump 46 and also stops the voltage application to the first liquid level sensor 43.

The controller 100b measures the elapsed time after the operation of the liquid pump 46 is stopped. When the elapsed time exceeds a first predetermined time, the controller 100b energizes, in other words, applies a voltage to the electrodes of the first liquid level sensor 43 and performs the detection process of detecting the liquid level of the liquid in the first liquid storage tank 44 again.

It takes time for the liquid stored in the first liquid storage tank 44 to be drawn up by capillary action of the liquid supply member 50 and sent from the immersion portion 502 to the liquid application member 501 through the liquid supply member 50. For this reason, the controller 100b detects the liquid level of the liquid in the first liquid storage tank 44 after waiting for the predetermined time to elapse as described above. At this time, if the liquid supply member 50 draws up the liquid, the liquid level of the liquid in the first liquid storage tank 44 decreases, and the liquid level of the liquid in the first liquid storage tank 44 is not detected, the controller 100b again operates the liquid pump 46 to supply the liquid from the second liquid storage tank 47 to the first liquid storage tank 44.

The output value of the first liquid level sensor 43 corresponds to an electrical signal that changes according to the amount of contact of the electrodes with the liquid in the first liquid storage tank 44. Examples of the electrical signal include, but not limited to, a signal indicating an electrical resistance value, a signal indicating a voltage value, and a signal indicating a current value. In other words, a signal indicating an electrical value that changes when the electrodes are energized, in other words, when a voltage is applied depending on whether or not the pair of electrodes constituting the electrode sensor is immersed in the liquid corresponds to an “electrical signal”.

In the present embodiment, the electrode sensor has been described as an example of the first liquid level sensor 43. However, the first liquid level sensor is not limited to the electrode sensor and may be other types of sensors. For example, a float sensor or a capacitance sensor may be used to detect the presence or absence of the liquid. The first liquid level sensor 43 may be any sensor as long as it can detect the amount of liquid stored in the first liquid storage tank 44, and is not limited to the sensor that detects the liquid level of the liquid in the first liquid storage tank 44.

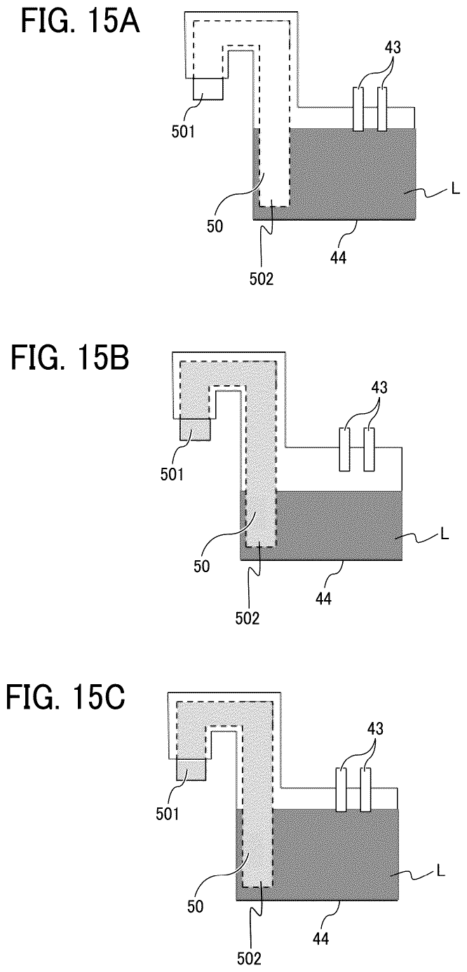

FIGS. 15A to 15C are diagrams illustrating a change in the liquid level of the liquid in the first liquid storage tank 44 when the liquid supply member 50 is dry.

A change in the liquid level of the liquid in the first liquid storage tank 44 is referred to as a “liquid level change” below.

First, as illustrated in FIG. 15A, liquid is supplied from the second liquid storage tank 47 to the first liquid storage tank 44, and the first liquid level sensor 43 is set to detect the liquid level of the liquid in the first liquid storage tank 44. At this time, the liquid supply member 50 including the immersion portion 502 is dry. The liquid level when the first liquid level sensor 43 detects the liquid in the first liquid storage tank 44, in other words, the amount of liquid stored in the first liquid storage tank 44 detected by the first liquid level sensor 43 is defined as a “reference liquid level”.

Then, as illustrated in FIG. 15B, the liquid is sucked up from the immersion portion 502 of the liquid supply member 50 by capillary action, and the liquid supply member 50 is moistened with the sucked liquid. At this time, the liquid level of the liquid in the first liquid storage tank 44 is lowered from the reference liquid level. At the stage when the liquid level is lowered, in other words, at the stage when the liquid supply member 50 is moistened by sucking the liquid, the controller 100b determines the output value from the first liquid level sensor 43 again. At this stage, when the controller 100b determines that the liquid level of the liquid in the first liquid storage tank 44 is less than the reference liquid level, the controller 100b operates the liquid pump 46 to supply the liquid from the second liquid storage tank 47 to the first liquid storage tank 44 again.

In a case where an electrode sensor is used as the first liquid level sensor 43, there is a concern that the metal used for the electrodes might be corroded due to electrolytic corrosion if the pair of electrodes is energized constantly. Further, since the voltage is always applied to the liquid stored in the first liquid storage tank 44, there is a concern that the liquid might be electrolyzed or that the electrodes might be dissolved due to adhesion of foreign matter to the surface of the electrodes by electrolysis, which might induce deterioration of the electrodes. For this reason, the controller 100b controls the timing of energization to the first liquid level sensor 43 such that the first liquid level sensor 43 is not energized all the time but the energization thereof is turned on only when detecting the liquid level of the liquid in the first liquid storage tank 44.

### Control Process of Liquid Supply Operation

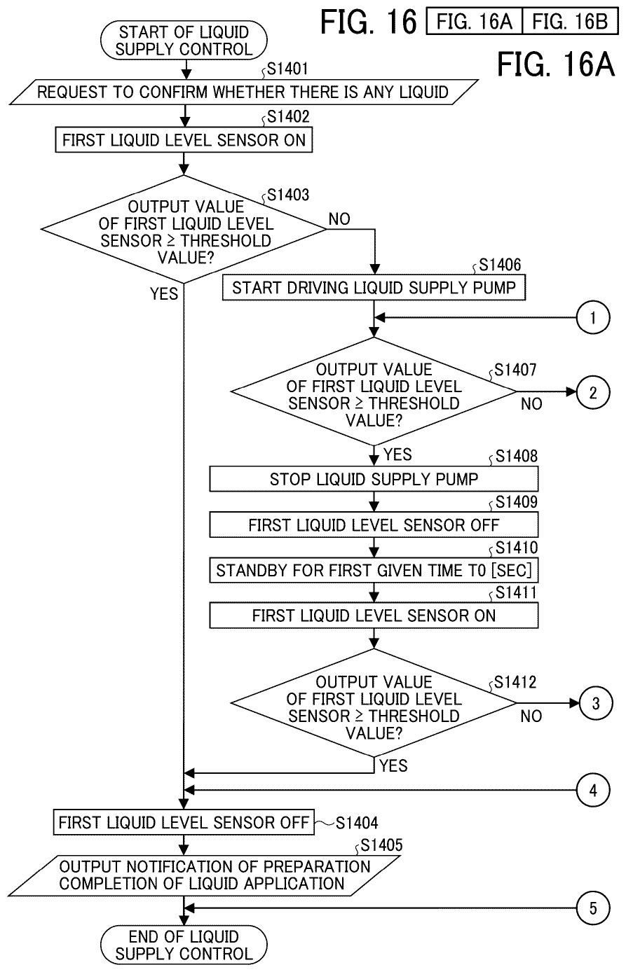

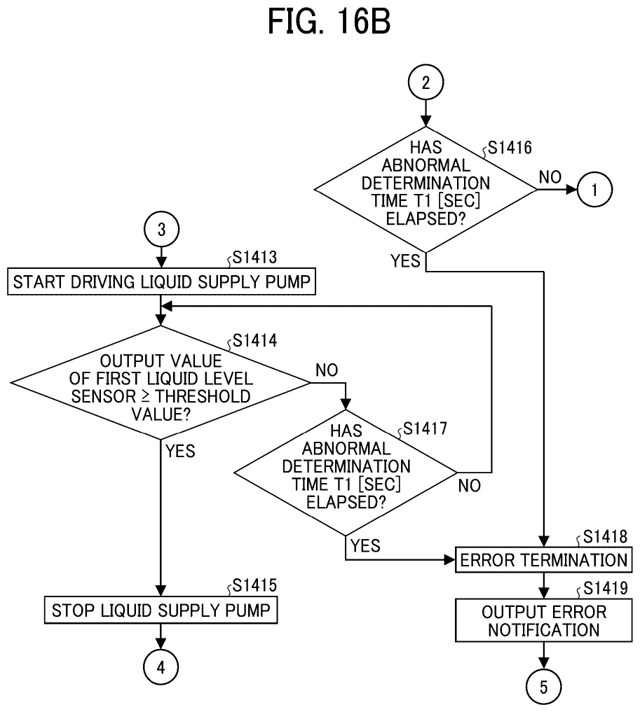

FIG. 16 is a flowchart illustrating a control process (referred to as a “liquid supply control process”) of the liquid supply operation performed in the controller 100b.

The liquid supply operation according to the present embodiment is executed at the time of starting the post-processing apparatus 3 or at the time of starting the crimp binding process involving liquid application.

For example, when the post-processing apparatus 3 is activated, the liquid supply control process is started. When the liquid supply control process is started, a liquid presence check request is instructed from the image forming apparatus 2 to the controller 100b (step S1401). The liquid presence check request may be instructed based on information input by the user from the control panel 110 of one or both of the image forming apparatus 2 and the post-processing apparatus 3. In response to receipt of the liquid presence check request instructed from the image forming apparatus 2, the controller 100b applies a voltage to the first liquid level sensor 43, in other words, turns on the energization (step S1402).

Subsequently, the controller 100b acquires a value of an electrical signal (referred to as an “output value” in the following description) output when the first liquid level sensor 43 detects liquid in the first liquid storage tank 44, and determines the liquid level of the liquid in the first liquid storage tank 44 (step S1403). The determination of the liquid level of the liquid in the first liquid storage tank 44 is performed based on whether the output value from the first liquid level sensor 43 exceeds a “liquid detection threshold value” as a threshold value set in advance. For example, when the output value from the first liquid level sensor 43 is equal to or greater than the liquid detection threshold value (for example, output voltage VTh1), the controller 100b determines that the liquid level of the liquid in the first liquid storage tank 44, in other words, the amount of liquid stored in the first liquid storage tank 44 is a sufficient amount (YES in step S1403). In this case, the controller 100b stops the application of the voltage to the first liquid level sensor 43, in other words, turns off the energization of the first liquid level sensor 43 (step S1404), displays a completion notice of the preparation for liquid application on, for example, the control panel 110 (step S1405), and ends the liquid supply control process.

On the other hand, when the output value from the first liquid level sensor 43 is less than the liquid detection threshold value (for example, the output voltage VTh1) in step S1403 (NO in step S1403), the controller 100b operates the liquid pump 46 to execute the supply of the liquid from the second liquid storage tank 47 to the first liquid storage tank 44 (step S1406).

Subsequently, the controller 100b determines whether the output value from the first liquid level sensor 43 is equal to or greater than the “liquid detection threshold value” set in advance (step S1407). When the output value from the first liquid level sensor 43 is equal to or greater than the liquid detection threshold value (for example, the output voltage VTh1), the controller 100b determines that a sufficient amount of liquid has been supplied from the second liquid storage tank 47 into the first liquid storage tank 44 by the liquid pump 46 (YES in step S1407). On the other hand, when the output value from the first liquid level sensor 43 is less than the liquid detection threshold value (for example, the output voltage VTh1) (NO in step S1407), the controller 100b determines whether an elapsed time from the start of the operation of the liquid pump 46 (step S1406) has reached an abnormality determination time T1 (seconds (sec)) (step S1416). When the elapsed time has not reached the abnormality determination time T1 (NO in step S1416), the controller 100b continues the supply of the liquid from the second liquid storage tank 47 to the first liquid storage tank 44 by the liquid pump 46 until the output value from the first liquid level sensor 43 becomes equal to or greater than the liquid detection threshold value (for example, output voltage V1) (YES in step S1407).

On the other hand, when the elapsed time has reached the abnormality determination time T1 (YES in step S1416), the controller 100b determines that some abnormality (such as a failure of at least one of the liquid pump 46 or the first liquid level sensor 43) has occurred in an apparatus, and executes an error stop process of at least one of stopping the liquid pump 46 and turning off the energization of the first liquid level sensor 43 (step S1418). The controller 100b causes the control panel 110 to display an abnormality notification (step S1419), and ends the liquid supply control process.

When the output value from the first liquid level sensor 43 becomes equal to or greater than the liquid detection threshold value (for example, output voltage VTh1) in step S1407 (YES in step S1407), the controller 100b stops the liquid pump 46 and stops the supply of liquid from the second liquid storage tank 47 to the first liquid storage tank 44 (step S1408). Then, the controller 100b turns off the energization of the first liquid level sensor 43 (step S1409).

Then, the liquid supply control process is temporarily stopped until a first predetermined time T0 (seconds (sec)) elapses. The standby time is set in advance as a time taken until the liquid supply member 50 sucks up liquid in the first liquid storage tank 44 by, for example, capillary action and the liquid application member 501 turns to an executable state for liquid application, in other words, a state where the liquid is sufficiently stored in at least one of the liquid application member 501 and the liquid supply member 50 (step S1410).

After the first predetermined time T0 has elapsed, the controller 100b turns on the energization of the first liquid level sensor 43 again (step S1411), acquires an output value that is output when the first liquid level sensor 43 detects the liquid in the first liquid storage tank 44, and determines the liquid level of the liquid in the first liquid storage tank 44, in other words, the amount of liquid stored in the first liquid storage tank 44 (step S1412). At this stage, the liquid level of the liquid in the first liquid storage tank 44 is lowered by the suction of the liquid supply member 50. However, if the output value from the first liquid level sensor 43 is equal to or greater than the liquid detection threshold value (for example, the output voltage VTh1) (YES in step S1412), the controller 100b turns off the energization of the first liquid level sensor 43 (step S1404). The controller 100b displays a completion notice of the preparation for liquid application on, for example, the control panel 110 (step S1405), and ends the liquid supply control process.

On the other hand, when the output value from the first liquid level sensor 43 is less than the liquid detection threshold value (for example, the output voltage VTh1) in step S1412 (NO in step S1412), the controller 100b operates the liquid pump 46 to execute the supply of the liquid from the second liquid storage tank 47 to the first liquid storage tank 44 (step S1413).

Subsequently, the controller 100b acquires an output value that is output when the first liquid level sensor 43 detects liquid in the first liquid storage tank 44, and determines the liquid level of the liquid in the first liquid storage tank 44, in other words, the amount of liquid stored in the first liquid storage tank 44 (step S1414). Subsequently, when the output value from the first liquid level sensor 43 is equal to or greater than the liquid detection threshold value (for example, the output voltage VTh1) (YES in step S1414), the controller 100b determines that a sufficient amount of liquid has been supplied into the first liquid storage tank 44. In this case, the controller 100b stops the liquid pump 46 to stop the supply of liquid from the second liquid storage tank 47 to the first liquid storage tank 44 (step S1415). The controller 100b turns off the energization of the first liquid level sensor 43 (step S1404), displays a completion notice of the preparation for liquid application on, for example, the control panel 110 (step S1405), and ends the liquid supply control process.

On the other hand, when the output value from the first liquid level sensor 43 is less than the liquid detection threshold value (for example, the output voltage VTh1) (NO in step S1414), the controller 100b determines whether an elapsed time from the start of the operation of the liquid pump 46 (step S1413) has reached the abnormality determination time T1 (seconds (sec)) (step S1417). When the elapsed time has not reached the abnormality determination time T1 (NO in step S1417), the controller 100b continues the supply of the liquid from the second liquid storage tank 47 to the first liquid storage tank 44 by the liquid pump 46 until the output value from the first liquid level sensor 43 becomes equal to or greater than the liquid detection threshold value (for example, the output voltage VTh1) (YES in step S1414).

On the other hand, when the elapsed time has reached the abnormality determination time T1 (YES in step S1414), the controller 100b determines that some abnormality has occurred in the apparatus, and executes the error stop process of at least one of stopping the liquid pump 46 and turning off the energization of the first liquid level sensor 43 (step S1418). The controller 100b causes the control panel 110 to display an abnormality notification (step S1419), and ends the liquid supply control process.

The “abnormality notification” may be, for example, a display of a warning on the control panel 110 to prompt a check because there is a possibility that one or both of the liquid pump 46 and the first liquid level sensor 43 are out of order.

As described above, the execution of the control process of the liquid supply operation according to the present embodiment can stably obtain a certain amount of liquid in at least one of the liquid supply member 50 and the liquid application member 501, which enables liquid application by the liquid application member 501. As a result, the frequency of the liquid supply operation from the second liquid storage tank 47 to the first liquid storage tank 44 can be reduced, and the efficiency of the liquid application process can be enhanced.

A description is given below of the relation between the liquid supply control process, with reference to FIG. 16, and the change in the liquid level of the liquid in the first liquid storage tank 44, in other words, the amount of liquid stored in the first liquid storage tank 44, with reference to FIGS. 15A to 15C.

First, when the presence or absence of liquid in the first liquid storage tank 44 is checked in the stage preceding to the state illustrated in FIG. 15A, the controller 100b determines that the state in the first liquid storage tank 44 is the state of “no liquid” (NO in step S1403) and drives the liquid pump 46 to supply liquid from the second liquid storage tank 47 to the first liquid storage tank 44 (step S1406). When the amount (liquid level) of the liquid stored in the first liquid storage tank 44 reaches the state of FIG. 15A, the output value from the first liquid level sensor 43 becomes equal to or greater than the liquid detection threshold value (for example, the output voltage VTh1) (YES in step S1407). The controller 100b stops the liquid pump 46 (step S1408) and turns off the energization of the first liquid level sensor 43 (step S1409).

Subsequently, when the first predetermined time T0, which is set in advance as the time taken until the liquid supply member 50 sucks up liquid as illustrated in FIG. 15B and the liquid application member 501 turns to an executable state for liquid application, has elapsed, the controller 100b turns on the energization of the first liquid level sensor 43 again (step S1411). At this stage, a predetermined amount of liquid is sucked up by the liquid supply member 50 from the first liquid storage tank 44 to the liquid supply member 50. As a result, the amount of the liquid stored in the first liquid storage tank 44 decreases and the liquid level of the liquid in the first liquid storage tank 44 becomes lower than the reference liquid level. As a result, the output value from the first liquid level sensor 43 becomes less than the liquid detection threshold value (for example, the output voltage VTh1) (NO in step S1412).

Then, the controller 100b causes the liquid pump 46 to operate again (step S1413) and executes supply of the liquid from the second liquid storage tank 47 to the first liquid storage tank 44 until the output value from the first liquid level sensor 43 becomes equal to or greater than the liquid detection threshold value (for example, the output voltage VTh1) (YES in step S1414). When the output value from the first liquid level sensor 43 becomes equal to or greater than the liquid detection threshold value (for example, the output voltage VTh1), the controller 100b stops the liquid pump 46 (step S1415) and turns off the energization of the first liquid level sensor 43 (step S1404). As a result, as illustrated in FIG. 15C, the liquid in the first liquid storage tank 44 is sufficiently stored in the entirety of at least one of the liquid supply member 50 or the liquid application member 501, and the controller 100b causes the control panel 110 to display the completion notification of the preparation for liquid application (step S1405).

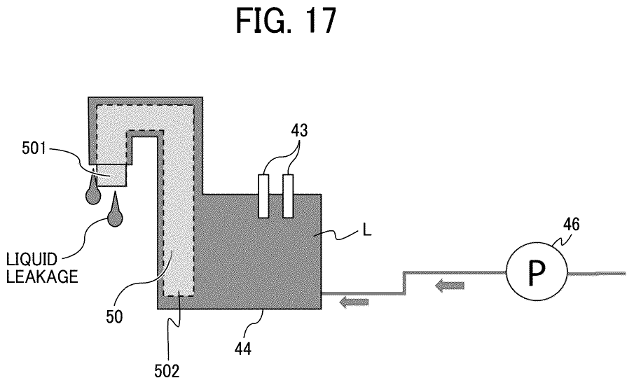

FIG. 17 is a diagram illustrating liquid leakage that might occur in the liquid applier 31 according to the present embodiment.

The liquid applier 31 according to the present embodiment supplies liquid to the second liquid storage tank 47. Accordingly, the properties (for example, hardness, pH, chlorine content, and conductance) of the liquid vary depending on the type of the liquid supplied to the second liquid storage tank 47. In other words, when the liquid level of the liquid in the first liquid storage tank 44, in other words, the amount of liquid stored in the first liquid storage tank 44 is determined based on the output value of the first liquid level sensor 43, it is assumed that a situation may arise in which it is difficult to accurately detect the amount of liquid stored in the first liquid storage tank 44 even if the determination is made with the liquid detection threshold value fixed at a specific value.

For example, it is assumed that the liquid supplied into the first liquid storage tank 44 is a liquid having extremely low conductance (for example, ultrapure water used in the industrial field). It is further assumed that the liquid detection threshold value set on the premise of tap water is used. In such a case, even when the liquid in the first liquid storage tank 44 contacts the first liquid level sensor 43, the output value, in other words, output value of ultrapure water at that time may not satisfy the condition for detecting the liquid level of the liquid in the first liquid storage tank 44 in comparison with the liquid detection threshold value set on the premise of tap water. As a result, the supply of the liquid to the first liquid storage tank 44 by the liquid pump 46 would not be stopped at an appropriate timing, and the first liquid storage tank 44 would entirely be filled with the liquid, which may cause a failure such as a gap between the liquid supply member 50 and the first liquid storage tank 44 or liquid leakage from the tip of the liquid application member 501 as illustrated in FIG. 17.

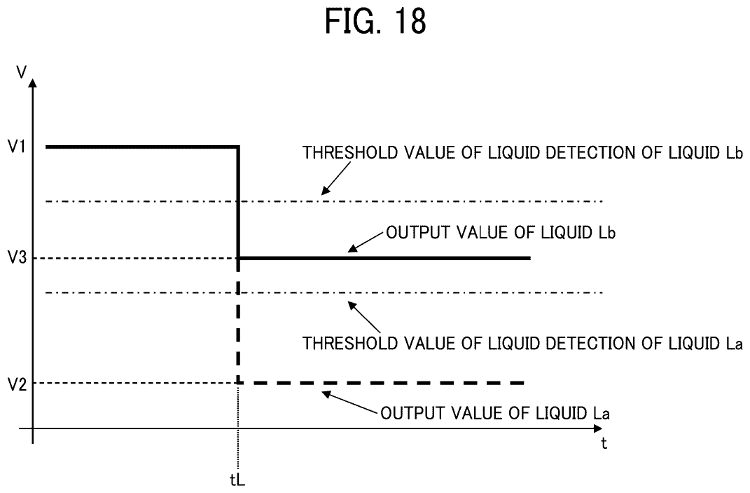

For this reason, the liquid applier 31 according to the present embodiment varies the liquid detection threshold value used for determining the presence or absence of the liquid in the first liquid level sensor 43 depending on the type of the liquid. FIG. 18 is a graph illustrating the relation between the change in the output value from the first liquid level sensor 43 and the liquid detection threshold value of the first liquid level sensor 43 in time series. In FIG. 18, the horizontal axis t represents the elapsed time when the liquid pump 46 is operated to supply the liquid from the second liquid storage tank 47 to the first liquid storage tank 44, and the vertical axis V represents the output value of the first liquid level sensor 43.

Before the pair of electrodes of the first liquid level sensor 43 comes into contact with the liquid in the first liquid storage tank 44 (see FIG. 15B), the air is detected with the first liquid level sensor 43. The output value of the first liquid level sensor 43 at this time is referred to as “V1”. If the liquid type is “La” having a predetermined conductance, the output value is assumed to change from “V1” to “V2” when the liquid La contacts the electrodes at the elapsed time tL. Then, in order to detect the liquid La with the first liquid level sensor 43, the controller 100b sets the liquid detection threshold value of the first liquid level sensor 43 between the output value V1 and the output value V2 as illustrated in FIG. 18.

The liquid detection threshold value of the first liquid level sensor 43 is preferably set to an intermediate value between the output value V1 and the output value V2 in consideration of, for example, variations and noise in the output value V1 and the output value V2.

In addition, in the case where the liquid type is not “La” but “Lb” having a lower conductance than “La”, the output value is assumed to change from “V1” to “V3” when the liquid Lb comes into contact with the electrodes. The output value V3 is assumed to be greater than the output value V2 and smaller than the output value V1.

In this case, when the liquid Lb comes into contact with the electrodes at the elapsed time tL, the output value changes from “V1” to “V3” and does not reach “V2”. In other words, even if the liquid detection threshold value of the first liquid level sensor 43 is set, as the liquid detection threshold value for the liquid La, to the intermediate value between the output value V1 and the output value V2 as illustrated in FIG. 18, the liquid level of the liquid Lb in the first liquid storage tank 44 is not detected by the first liquid level sensor 43.

For this reason, in the case of the liquid Lb, the controller 100b resets the liquid detection threshold value of the first liquid level sensor 43 to an intermediate value between the output value V1 and the output value V3, not the intermediate value between the output value V1 and the output value V2 as illustrated in FIG. 18. In other words, the liquid detection threshold value of the first liquid level sensor 43 is changed depending on the type of the liquid such that the first liquid level sensor 43 can accurately detect the liquid level of the liquid in the first liquid storage tank 44.

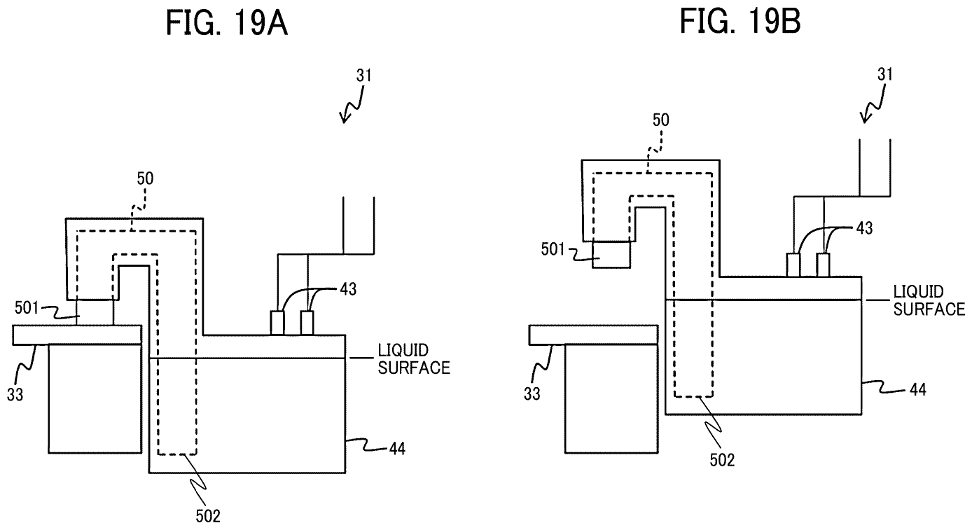

FIGS. 19A and 19B are schematic views of the liquid applier 31 when the liquid application member 501 is at a liquid application position and a separated position.

As illustrated in FIGS. 19A and 19B, the liquid applier 31 includes the first liquid storage tank 44, the first liquid level sensor 43, the liquid supply member 50, the liquid application member 501, and the contact-separation motor 32d (see FIG. 10) which is an example of the contact-separation unit. Since the basic configuration of each component is as described above, detailed description thereof is omitted.

The first liquid storage tank 44 has a shape of a box that stores liquid. The first liquid level sensor 43 detects the liquid level of the liquid in the first liquid storage tank 44, in other words, the amount of liquid stored in the first liquid storage tank 44. One end of the liquid supply member 50 is immersed in the liquid in the first liquid storage tank 44. The liquid supply member 50 has the other end to which the liquid application member 501 is attached. Furthermore, a portion between one end and the other end of the liquid supply member 50 is exposed from the liquid in the first liquid storage tank 44. The liquid application member 501 is attached to the other end of the liquid supply member 50 at an upward portion of the lower pressure plate 33, in other words, at a position to face the sheet P that is supported by the lower pressure plate 33. The liquid stored in the first liquid storage tank 44 is drawn up to the liquid supply member 50 by capillary action of the liquid supply member 50, and is supplied to the liquid application member 501 attached to the other end of the liquid supply member 50.

The contact-separation motor 32d integrally moves the first liquid storage tank 44, the liquid supply member 50, and the liquid application member 501 in the thickness direction of the sheet P or the sheet bundle Pb. Then, the liquid application member 501 moved in the thickness direction of the sheet P or the sheet bundle Pb by the contact-separation motor 32d moves in the thickness direction of the sheet P or the sheet bundle Pb between the liquid application position illustrated in FIG. 19A and the separated position illustrated in FIG. 19B. The liquid application position is a position of the liquid application member 501 when the liquid application member 501 contacts the sheet P supported by the lower pressure plate 33 and applies the liquid to the sheet P. The separated position is a position of the liquid application member 501 separated upward in the thickness direction of the sheet P or the sheet bundle Pb from the sheet P supported by the lower pressure plate 33. In other words, the liquid application position and the separated position are positions separated in the thickness direction of the sheet P or the sheet bundle Pb.

Since there is a limit to the supply speed of liquid to the liquid application member 501 by capillary action, it is not likely that the supply of liquid to the liquid application member 501 is made in time as the frequency of liquid application by the liquid applier 31 increases. As a result, the first issue that the amount of liquid to be applied to the sheet P by the liquid applier 31 is unstable arises. In addition, when the liquid application is interrupted before a sufficient amount of liquid is supplied to the liquid application member 501, the second problem occurs in that the productivity of the liquid applier 31 is decreased.

### Modification

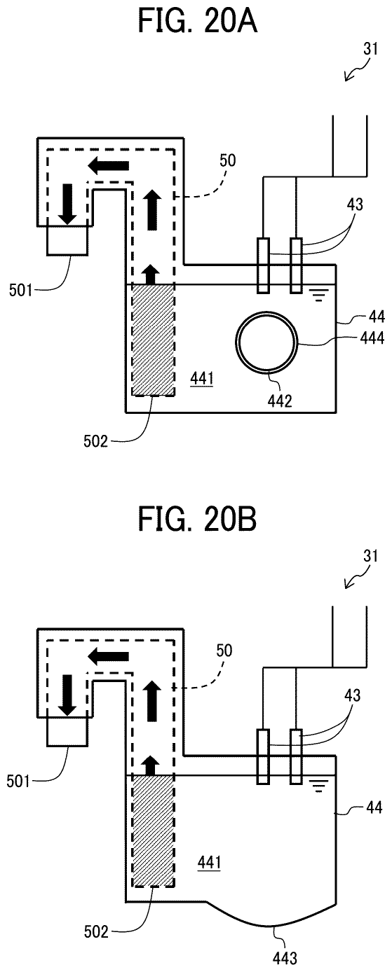

A description is given of a post-processing apparatus 3 according to a modification of the above-described embodiment, with reference to FIGS. 20A to 29.

Detailed descriptions will be omitted of common features of the above-described embodiment and the present modification. The following description is mainly given of the differences between the above-described embodiment and the present modification. The post-processing apparatus 3 according to the modification is mainly different from the above-described embodiment in that the first liquid storage tank 44 includes elastic walls 442 and 443 and includes pressing members 445, 458, and 459 as pressers that press the elastic walls 442 and 443, and is common to the above-described embodiment in other points.

FIGS. 20A and 20B are side views of a main part of a liquid applier 31 according to the modification.

As illustrated in FIGS. 20A and 20B, the liquid applier 31 mainly includes the first liquid storage tank 44, the liquid supply member 50, the liquid application member 501, and the first liquid level sensor 43, similarly to the above embodiment.

The first liquid storage tank 44 has a box shape having an internal space 441 for storing liquid. The internal space 441 of the first liquid storage tank 44 is defined by an outer wall. Elastic walls 442 and 443 are formed on a part of the outer wall. One face of the elastic walls 442 and 443 is exposed to the outside of the first liquid storage tank 44, and the other face defines a part of the internal space 441, in other words, is in contact with the internal space 441. In addition, the elastic walls 442 and 443 may swell outward from the outer wall of the first liquid storage tank 44 in a natural state, in other words, in a state where no external force other than gravity acts.

The elastic walls 442 and 443 are made of a material that can be elastically deformed by an external force. In other words, the elastic walls 442 and 443 have elasticity. The elastic walls 442 and 443 are made of, for example, rubber or flexible plastic (for example, polypropylene). On the other hand, the portion other than the elastic walls 442 and 443 of the outer wall of the first liquid storage tank 44 may be made of a material having a smaller elastic deformability (in other words, robust) than the elastic walls 442 and 443. Alternatively, the entire outer wall of the first liquid storage tank 44 may be constituted by the elastic walls 442 and 443.

As an example, as illustrated in FIG. 20A, the elastic wall 442 may be provided on a part of a side wall orthogonal to the main scanning direction in the outer wall of the first liquid storage tank 44. In addition, a sealing member 444 that prevents outflow of the liquid stored in the internal space 441 may be provided around the elastic wall 442. As another example, as illustrated in FIG. 20B, the elastic wall 443 may be provided on a part of the outer wall of the first liquid storage tank 44 that is orthogonal to the thickness direction of the sheet P or the sheet bundle Pb placed on the internal tray 22. However, the positions of the elastic walls 442 and 443 are not limited to the example of FIGS. 20A and 20B, and may be provided on at least a part of the outer wall of the first liquid storage tank 44.

The liquid supply member 50 is a long member made of a material having a high liquid absorption coefficient. The liquid application member 501 is attached to one end of the liquid supply member 50 outside the first liquid storage tank 44. The other end of the liquid supply member 50, in other words, the immersion portion 502 is housed in the internal space 441 of the first liquid storage tank 44 and is immersed in the liquid stored in the internal space 441.

The liquid supply member 50 sucks up the liquid stored in the internal space 441 of the first liquid storage tank 44 by capillary action and supplies the liquid to the liquid application member 501.

The liquid application member 501 is able to come into contact with and separate from the sheet P or the sheet bundle Pb supported by the internal tray 22 upon transmission of the driving force of the liquid applier movement motor 42 as a third movement assembly. Then, the liquid application member 501 comes into contact with the sheet P or the sheet bundle Pb placed on the internal tray 22, and applies the liquid supplied from the first liquid storage tank 44 through the liquid supply member 50 to the sheet P or the sheet bundle Pb. The first liquid level sensor 43 detects the liquid level of the liquid stored in the internal space 441 of the first liquid storage tank 44, and outputs a signal indicating the detected liquid level to the controller 110b.

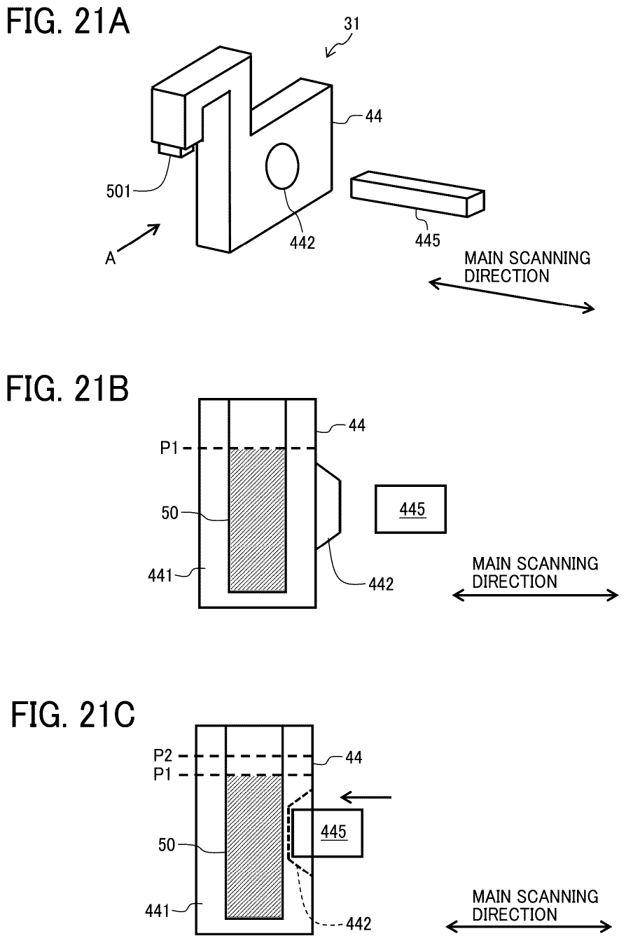

FIGS. 21A, 21B and 21C are diagrams illustrating a relationship between the elastic wall 442 and the pressing member 445 as a presser.

FIGS. 21B and 21C are diagrams as viewed from the direction of arrow A of FIG. 21A.

As illustrated in FIGS. 21A, 21B and 21C, the pressing member 445 is disposed outside the first liquid storage tank 44. The pressing member 445 is disposed to face the elastic wall 442 in the main scanning direction. In other words, the pressing member 445 is disposed at a position overlapping the elastic wall 442 when the post-processing apparatus 3 is viewed from the main scanning direction. In other words, the pressing member 445 is disposed at a position where the elastic wall 442 can be pressed from the outside of the first liquid storage tank 44.

The pressing member 445 can be separated from the elastic wall 442 as illustrated in FIG. 21B, and can press the elastic wall 442 from the outside as illustrated in FIG. 21C. The elastic wall 442 pressed from the outside by the pressing member 445 is elastically deformed toward the internal space 441 of the first liquid storage tank 44 to reduce the volume of the internal space 441 of the first liquid storage tank 44. Further, when the pressing member 445 is separated from the elastic wall 442, the elastic wall 442 elastically returns to the original state, and increases the volume of the internal space 441 of the first liquid storage tank 44 to the initial state.

Thus, the liquid level of the liquid stored in the internal space 441 of the first liquid storage tank 44 is temporarily higher at a position P2 when the pressing member 445 presses the elastic wall 442 than at a position P1 when the pressing member 445 is separated from the elastic wall 442. As a result, the contact area between the liquid stored in the internal space 441 of the first liquid storage tank 44 and the liquid supply member 50 increases, and the supply speed of the liquid supplied from the first liquid storage tank 44 to the liquid application member 501 via the liquid supply member 50 increases. On the other hand, after the liquid stored in the internal space 441 of the first liquid storage tank 44 is supplied to the liquid application member 501, by separating the pressing member 445 from the elastic wall 442, the amount of liquid that can be stored in the internal space 441 of the first liquid storage tank 44 can be ensured.

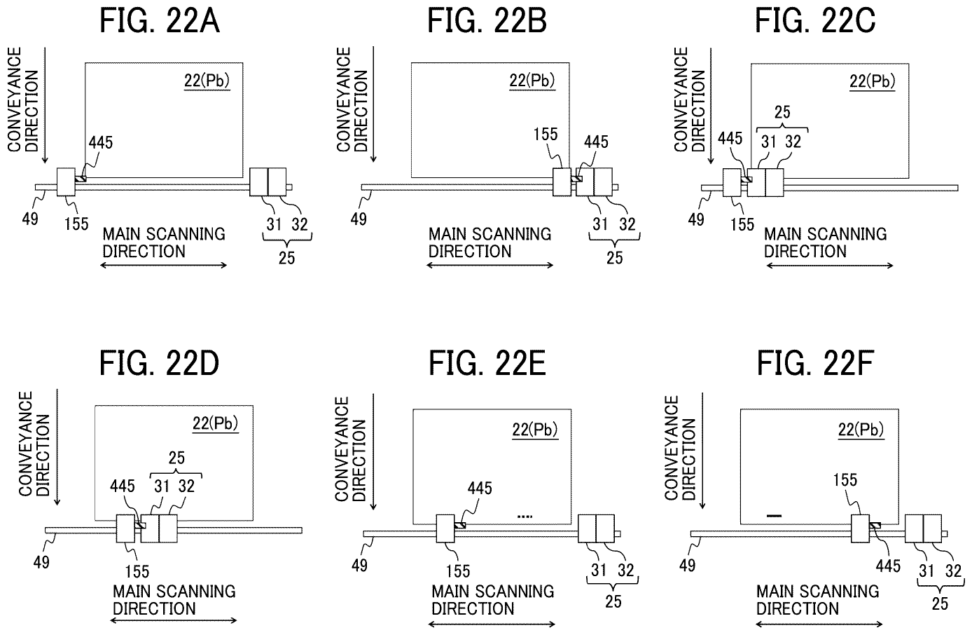

FIGS. 22A, 22B, 22C, 22D, 22E and 22F are diagrams illustrating an example in which the pressing member 445 is provided in the staple binder 155.

As illustrated in FIGS. 22A, 22B, 22C, 22D, 22E and 22F, the liquid applier 31, the crimper 32 as a first processing device, and the staple binder 155 as a second processing device are movable in the main scanning direction along the common guide shaft 49. The edge binder 25 including the liquid applier 31 and the crimper 32 moves in the main scanning direction with the driving force transmitted from the edge binder movement assembly 57 as the first movement assembly. Further, a driving force is transmitted from the staple binder movement assembly 77 as the second movement assembly, and the staple binder 155 moves in the main scanning direction independently of the edge binder 25. In other words, the edge binder 25 and the staple binder 155 partially overlap each other in the movement path in the main scanning direction.

In the examples of FIGS. 22A to 22F, the pressing member 445 is provided in the staple binder 155. More particularly, the pressing member 445 protrudes in the main scanning direction from a surface of the staple binder 155 facing the liquid applier 31 toward the liquid applier 31. Further, the pressing member 445 is disposed at a position overlapping the elastic wall 442 when viewed from the main scanning direction.

Then, as illustrated in FIG. 22A, when the edge binder 25 is disposed at a position deviated to one side in the main scanning direction from the internal tray 22 and the staple binder 155 is disposed at a position deviated to the other side in the main scanning direction from the internal tray 22, the pressing member 445 is separated from the elastic wall 442. As illustrated in FIGS. 22B to 22D, by moving one or both of the edge binder 25 and the staple binder 155 in the main scanning direction, the elastic wall 442 can be pressed by the pressing member 445 at any position on the guide shaft 49, in other words, a position facing the internal tray 22 or a position deviated from the internal tray 22 in the main scanning direction.

Further, as illustrated in FIGS. 22E to 22F, the edge binder 25 can retract to a position where the pressing member 445 does not press the elastic wall 442 when performing the stapling process on any position of the sheet bundle Pb placed on the internal tray 22. Although omitted in the drawing, the staple binder 155 can retract to a position where the pressing member 445 does not press the elastic wall 442 when performing liquid application and crimp binding at any position of the sheet bundle Pb placed on the internal tray 22.

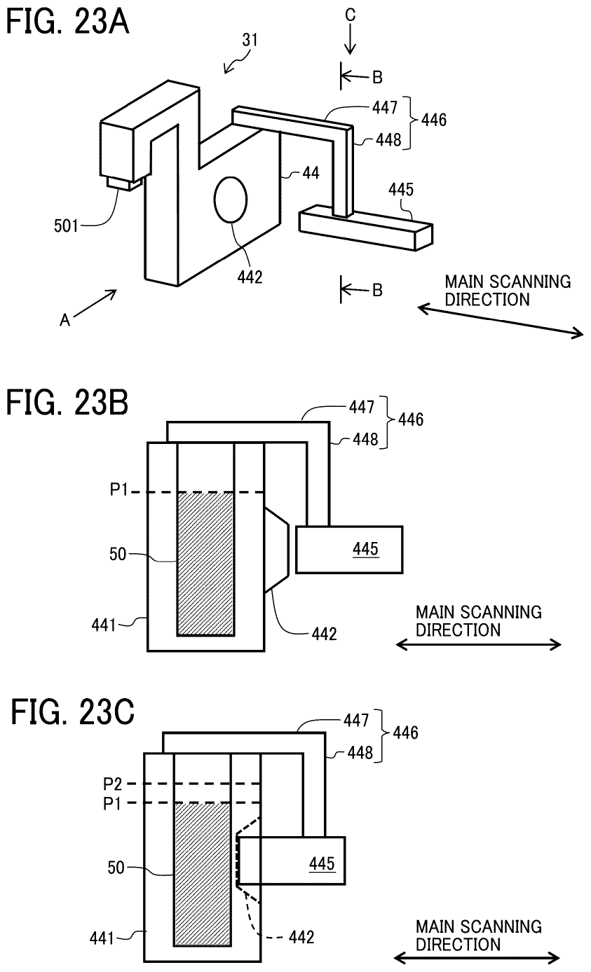

FIGS. 23A, 23B and 23C are diagrams illustrating an example in which the pressing member 445 is provided in the liquid applier 31.

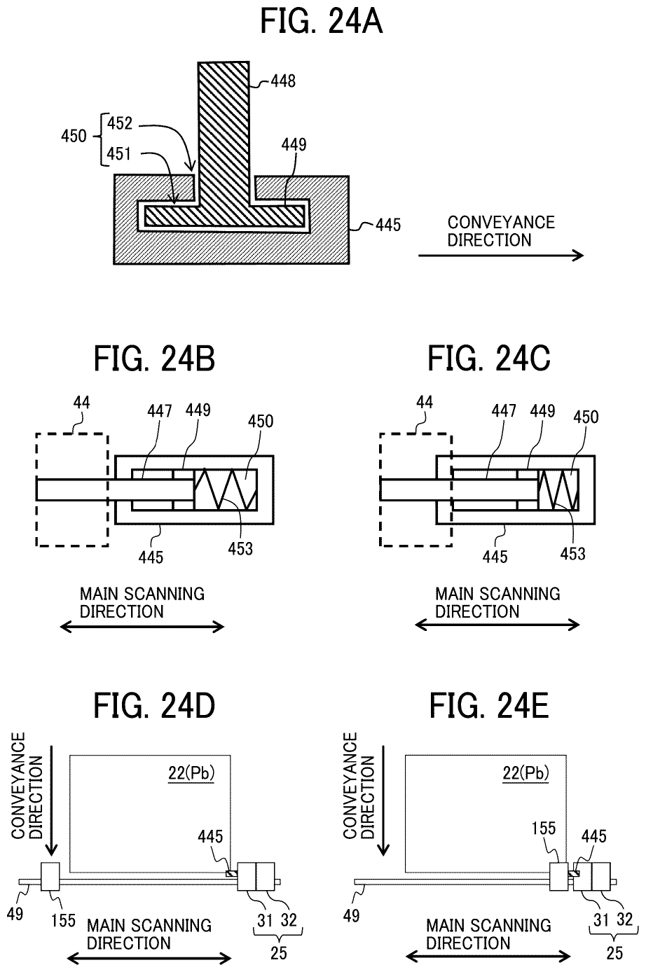

FIGS. 24A, 24B, 24C, 24D and 24E are diagrams for describing movement of the pressing member 445.

FIGS. 23B and 23C are diagrams of FIG. 23A as viewed from the direction of arrow A.

FIG. 24A is a diagram taken in the direction of arrows B-B in FIG. 23A.

Further, FIGS. 24B and 24C are diagrams of FIG. 23A as viewed from the direction of arrow C.

As illustrated in FIGS. 23A to 24E, the pressing member 445 may be held by the liquid applier 31 by the holding member 446. The holding member 446 includes an overhang portion 447 and a hanging portion 448. One end of the overhang portion 447 is fixed to the first liquid storage tank 44 and protrudes toward the staple binder 155 in the main scanning direction. The hanging portion 448 hangs down in the thickness direction of the sheet P or the sheet bundle Pb placed on the internal tray 22 from a projecting end of the overhang portion 447. The pressing member 445 is attached to a lower end of the hanging portion 448. Further, the pressing member 445 is provided at a position overlapping the elastic wall 442 when viewed from the main scanning direction.

Further, the pressing member 445 is movably held in the main scanning direction by the holding member 446 provided in the first liquid storage tank 44 between a position (see FIG. 23B) separated from the elastic wall 442 and a position (see FIG. 23C) where the elastic wall 442 is pressed from the outside. More particularly, the pressing member 445 is held movably in the main scanning direction by the holding member 446 by housing a locking portion 449 provided at a distal end of the hanging portion 448 in the housing groove 450 provided on an upper face of the pressing member 445.

The locking portion 449 extends from the lower end of the hanging portion 448 to both sides in the conveyance direction. The housing groove 450 extends in the main scanning direction on the upper face of the pressing member 445. The housing groove 450 includes a wide portion 451 and a narrow portion 452. The wide portion 451 is a portion capable of housing the locking portion 449 on the back side of the housing groove 450. The narrow portion 452 is a portion that is open to the upper face of the pressing member 445, through which the hanging portion 448 can pass, and through which the locking portion 449 cannot pass. Then, by housing the locking portion 449 in the wide portion 451 from one end portion of the pressing member 445 in the main scanning direction, the pressing member 445 is held movably in the main scanning direction by the holding member 446.

Furthermore, a coil spring 453 as a biasing member is housed in the housing groove 450. One end of the coil spring 453 is in contact with the inner wall of the housing groove 450 provided in the pressing member 445, and the other end is in contact with the locking portion 449. Then, the coil spring 453 biases the pressing member 445 in a direction away from the elastic wall 442.

In other words, as illustrated in FIGS. 23B, 24B, and 24D, when the staple binder 155 is separated from the pressing member 445, the pressing member 445 is separated from the elastic wall 442 by the biasing force of the coil spring 453. In addition, as illustrated in FIGS. 23C, 24C, and 24E, the pressing member 445 is pressed by the staple binder 155 moving in the direction approaching the liquid applier 31 to press the elastic wall 442 against the biasing force of the coil spring 453. Further, when the staple binder 155 is separated from the pressing member 445, the pressing member 445 is separated from the elastic wall 442 again by the biasing force of the coil spring 453.

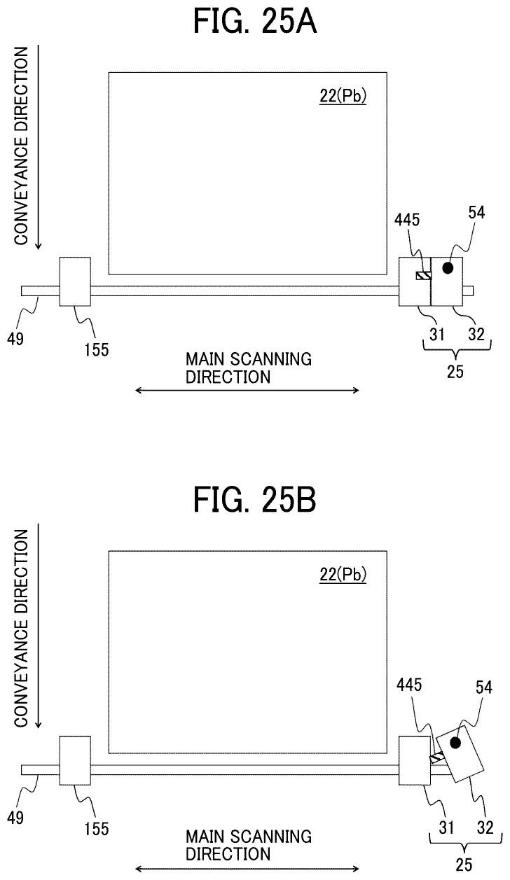

FIGS. 25A and 25B are diagrams illustrating an example in which the pressing member 445 is provided in the crimper 32.

As illustrated in FIGS. 25A and 25B, the pressing member 445 is provided on a surface of the crimper 32 facing the liquid applier 31. Although omitted in the drawing, the elastic wall 442 is disposed on a surface of the liquid applier 31 facing the crimper 32. Further, the driving force of the crimper pivot motor 56 as a pivot mechanism is transmitted, and the crimper 32 rotates around the crimper shaft 54 as a rotation shaft extending in the thickness direction of the sheet P or the sheet bundle Pb placed on the internal tray 22 between the parallel binding posture as the first posture illustrated in FIG. 25A and the oblique binding posture as the second posture illustrated in FIG. 25B.

As illustrated in FIG. 25A, the pressing member 445 is provided at a position to press the elastic wall 442 when the crimper 32 is in the parallel binding posture. On the other hand, as illustrated in FIG. 25B, the pressing member 445 is provided at a position separated from the elastic wall 442 when the crimper 32 is in the oblique binding posture.

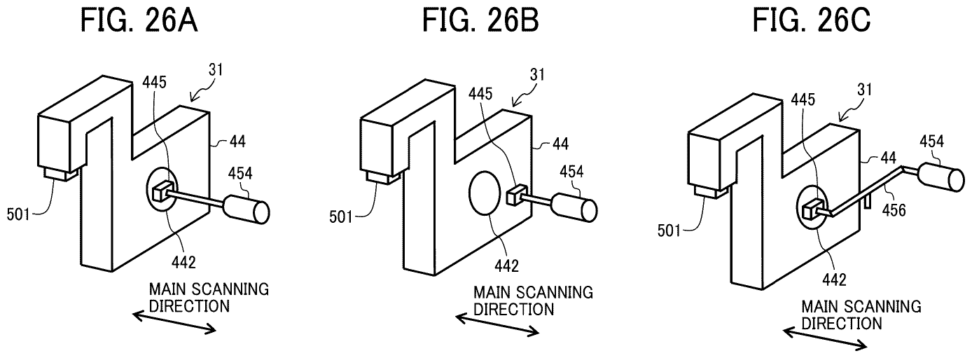

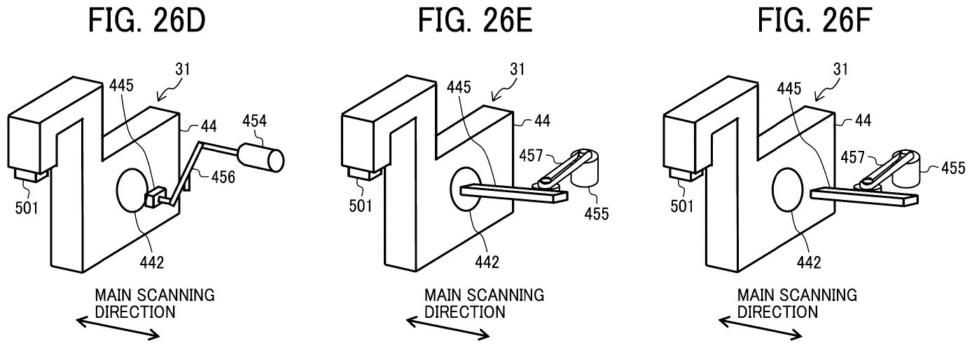

FIGS. 26A, 26B, 26C, 26D, 26E and 26F are diagrams illustrating an example in which the pressing member 445 is moved by a dedicated drive source.

The post-processing apparatus 3 may include a liquid supply promotion solenoid 454 illustrated in FIGS. 26A to 26D or a liquid supply promotion motor 455 illustrated in FIGS. 26E to 26F as a drive source for moving the pressing member 445 in the main scanning direction.

Further, the driving force of the liquid supply promotion solenoid 454 may be directly transmitted to the pressing member 445 as illustrated in, for example, FIGS. 26A and 26B, or may be transmitted to the pressing member 445 via the link mechanism 456 as illustrated in, for example, FIGS. 26C to 26D. Similarly, the driving force of the liquid supply promotion motor 455 may be transmitted to the pressing member 445 via the driving force transmission assembly 457 (including, for example, gears, endless annular belts, racks and pinions), for example, as illustrated in FIGS. 26E to 26F.

Then, the pressing member 445 moves in the main scanning direction between the pressing position illustrated in FIGS. 26A, 26C, and 26D and the separated position illustrated in FIGS. 26B, 26D, and 26F by driving the liquid supply promotion solenoid 454 or the liquid supply promotion motor 455 according to the control of the controller 110b. The pressing position is a position of the pressing member 445 that presses the elastic wall 442 from the outside. The separated position is a position of the pressing member 445 that is separated from the elastic wall 442.

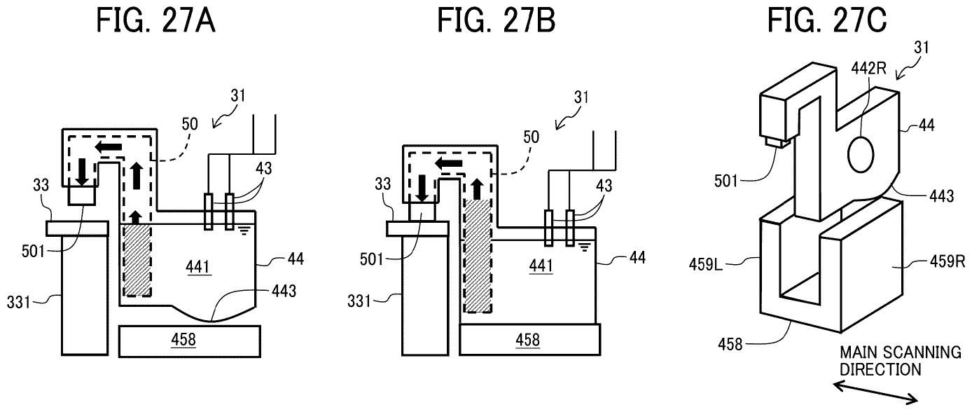

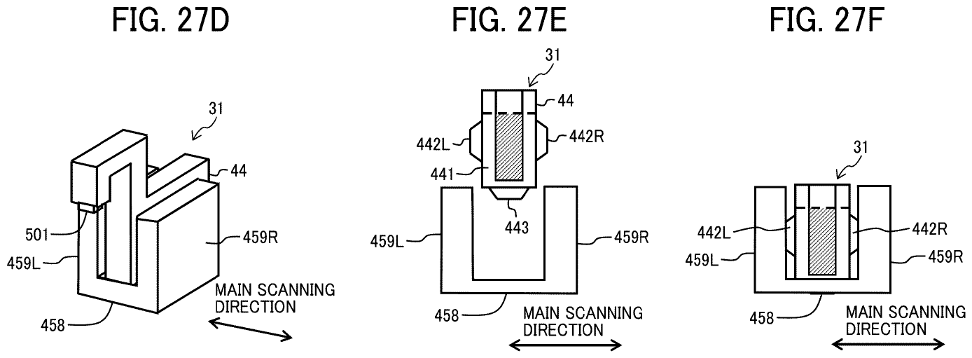

FIGS. 27A to 27F are diagrams illustrating an example in which the elastic walls 442 and 443 are pressed by the pressing members 458 and 459 as pressers in conjunction with the liquid applying operation of the liquid applier 31.

The driving force of the liquid applier movement motor 42 as the liquid application unit moving third movement assembly is transmitted, and the liquid applier 31 moves in the thickness direction of the sheet P or the sheet bundle Pb placed on the internal tray 22 between a contact position where the liquid application member 501 contacts the sheet P or the sheet bundle Pb and a separated position where the liquid application member 501 is separated from the sheet P or the sheet bundle Pb.

As illustrated in FIGS. 27A and 27B, the pressing member 458 may be a plate-like member located below the liquid applier 31. Then, the pressing member 458 faces the elastic wall 443 provided on the bottom face of the first liquid storage tank 44 in the thickness direction of the sheet P or the sheet bundle Pb placed on the internal tray 22. Further, the pressing member 458 moves in the main scanning direction together with the liquid applier 31. Then, as illustrated in FIG. 27A, the pressing member 458 is separated from the elastic wall 443 when the liquid applier 31 is at the separated position. On the other hand, as illustrated in FIG. 27B, the pressing member 458 presses the elastic wall 443 when the liquid applier 31 is at the contact position.

As illustrated in FIGS. 27C to 27F, the first liquid storage tank 44 may include elastic walls 442L, 442R, and 443. The elastic walls 442L and 442R are provided on a pair of wall faces orthogonal to the main scanning direction. The post-processing apparatus 3 may include pressing members 458, 459L, and 459R. The pressing members 459L and 459R protrude upward from the pressing member 458 at positions separated in the main scanning direction. Further, the interval between the pressing members 459L and 459R in the main scanning direction is narrower than the interval between the bulging ends of the elastic walls 442L and 442R in the natural state, in other words, in the state where the liquid applier 31 is at the separated position.

As illustrated in FIGS. 27C and 27E, when the liquid applier 31 is at the separated position, the elastic walls 442L and 442R are retracted upward from between the pressing members 459L and 459R, and the elastic wall 443 is separated from the pressing member 458. On the other hand, as illustrated in FIGS. 27D and 27F, when the liquid applier 31 is at the contact position, the elastic walls 442L and 442R are pressed inward between the pressing members 459L and 459R, and the elastic wall 443 is pressed by the pressing member 458.

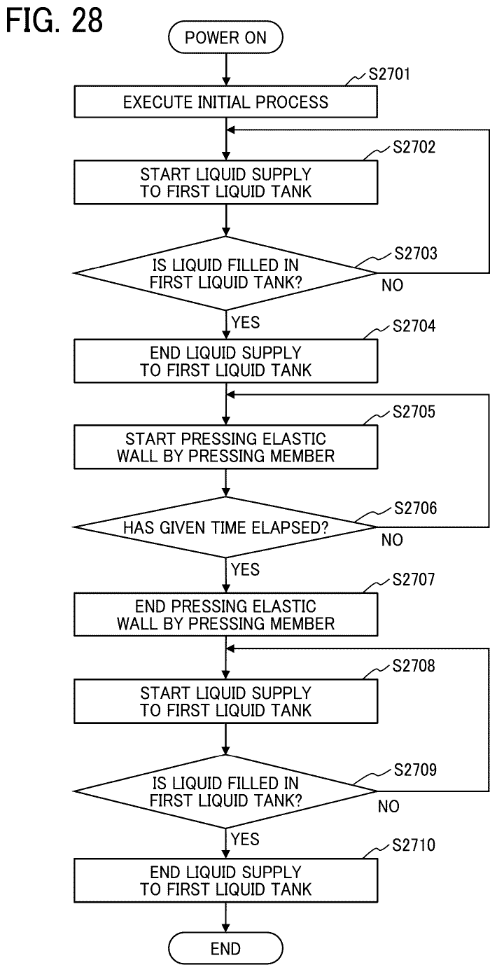

FIG. 28 is a flowchart of a process for promoting supply of liquid to the liquid application member 501 when the power is turned on.

First, when power supply from the external power supply to the post-processing apparatus 3 is started, the controller 110b executes predetermined initial processing (step S2701). The initial processing is preparation processing for enabling the post-processing apparatus 3 to execute post-processing.

The controller 110b drives the liquid pump 46 to supply the liquid in the second liquid storage tank 47 to the first liquid storage tank 44 (step S2702). The controller 110b continues to drive the liquid pump 46 until the first liquid level sensor 43 detects that the liquid level of the liquid in the first liquid storage tank 44 reaches a predetermined position (for example, full tank) (No in step S2703). Then, in response to detection of the liquid level of the liquid in the first liquid storage tank 44 by the first liquid level sensor 43 (Yes in step S2703), the controller 110b stops the liquid pump 46 (step S2704).

The controller 110b presses the elastic wall 442 with the pressing member 445 from the outside of the first liquid storage tank 44 to promote the supply of the liquid to the liquid application member 501 (step S2705). The controller 110b continues pressing the elastic wall 442 by the pressing member 445 until a predetermined time elapses (No in step S2706). Then, the controller 110b separates the pressing member 445 from the elastic wall 442 in response to the elapse of a predetermined time from the start of the pressing of the elastic wall 442 by the pressing member 445 (Yes in step S2706) (step S2707). In steps S2705 to S2707, the elastic walls 443, 442L, and 442R may be pressed by the pressing members 458, 459L, and 495R.

The controller 110b drives the liquid pump 46 to supply the liquid in the second liquid storage tank 47 to the first liquid storage tank 44 (step S2708). The controller 110b continues to drive the liquid pump 46 until the first liquid level sensor 43 detects that the liquid level of the liquid in the first liquid storage tank 44 reaches a predetermined position (for example, full volume) (No in step S2709). Then, in response to the detection of the liquid level of the liquid in the first liquid storage tank 44 by the first liquid level sensor 43 (Yes in step S2709), the controller 110b stops the liquid pump 46 (step S2710).

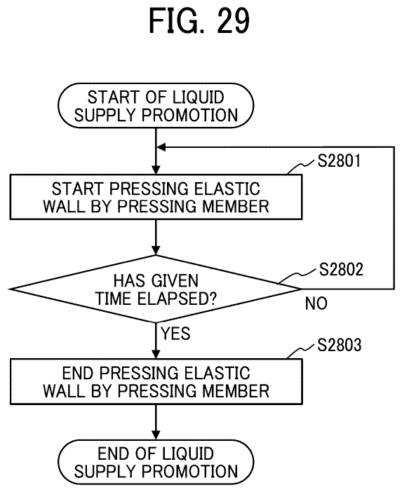

FIG. 29 is a flowchart of a liquid supply promotion operation of promoting the supply of the liquid in the first liquid storage tank 44 to the liquid application member 501 during the liquid application by the liquid applier 31 to the multiple sheets P.

For example, the controller 110b executes the control process of the liquid supply promotion operation described in FIG. 29 between the liquid application by the liquid applier 31 on the first sheet and the liquid application by the liquid applier 31 on the second sheet. More particularly, the controller 110b executes the control process of the liquid supply promotion operation illustrated in FIG. 29 after the liquid application by the liquid applier 31 to the first sheet is finished and before the liquid application by the liquid applier 31 to the second sheet is started (more preferably, before the second sheet reaches the internal tray 22). The second sheet is a sheet P conveyed to the internal tray 22 after the first sheet.

First, when the start of the liquid supply promotion operation is instructed, the controller 110b promotes the supply of the liquid in the first liquid storage tank 44 to the liquid application member 501 by pressing the elastic wall 442 with the pressing member 445 from the outside of the first liquid storage tank 44 (step S2801). The controller 110b continues the pressing of the elastic wall 442 with the pressing member 445 until a predetermined time elapses (No in step S2802). Then, the controller 110b separates the pressing member 445 from the elastic wall 442 (step S2803) in response to the elapse of a predetermined time from the start of the pressing of the elastic wall 442 (Yes in step S2802). In steps S2801 to S2803, the elastic walls 443, 442L, and 442R may be pressed by the pressing members 458, 459L, and 495R.

### Operation and Effect of Modification

According to the above modification, the volume of the internal space 441 of the first liquid storage tank 44 can be temporarily reduced by pressing the elastic wall 442 from the outside by the pressing member 445. Thus, the contact area between the liquid supply member 50 and the liquid in the first liquid storage tank 44 increases, so that the supply speed of the liquid in the first liquid storage tank 44 to the liquid application member 501 can be increased. In other words, the supply of the liquid in the first liquid storage tank 44 to the liquid application member 501 can be promoted.

According to the above modification, the elastic wall 442 is pressed by the pressing member 445 using the driving force of the edge binder movement assembly 57, the staple binder movement assembly 77, or the liquid applier movement motor 42, whereby the supply of the liquid in the first liquid storage tank 44 to the liquid application member 501 can be promoted without adding a new drive source. On the other hand, by providing a dedicated drive source for moving the pressing member 445 as illustrated in FIGS. 26A to 26F, the supply of the liquid in the first liquid storage tank 44 to the liquid application member 501 can be promoted at any timing.

Furthermore, according to the above modification, by promoting the supply of the liquid in the first liquid storage tank 44 to the liquid application member 501 at the timing of FIG. 28 or 29, an appropriate amount of liquid to the sheet P can be applied, and the operation of the post-processing apparatus 3 can be prevented from being temporarily stopped due to the insufficient supply of the liquid to the liquid application member 501 and to prevent a decrease in the binding strength of the sheet bundle Pb.

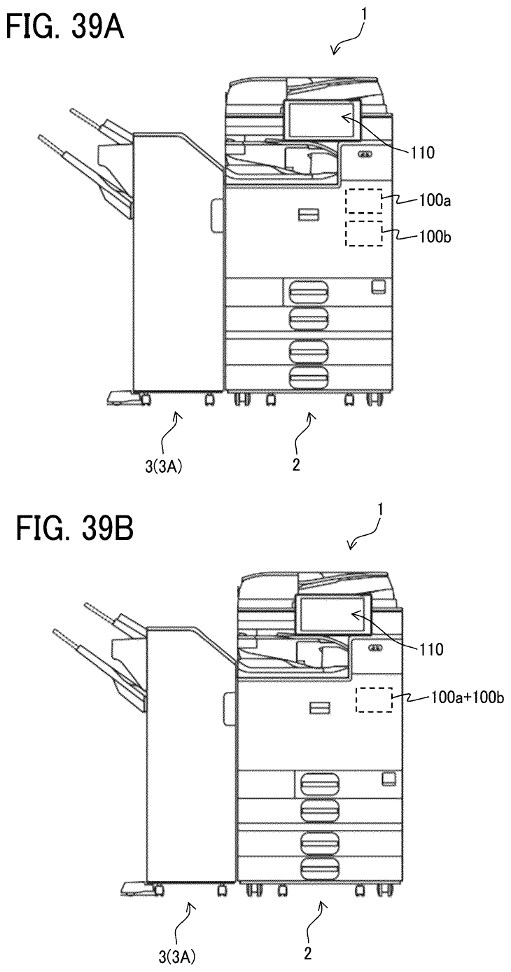

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 39A, the controller 100b of the post-processing apparatus 3 may be disposed in the image forming apparatus 2. Further, as illustrated in FIG. 39B, the controller 100b of the post-processing apparatus 3 may be integrated with the controller 100a of the image forming apparatus 2.

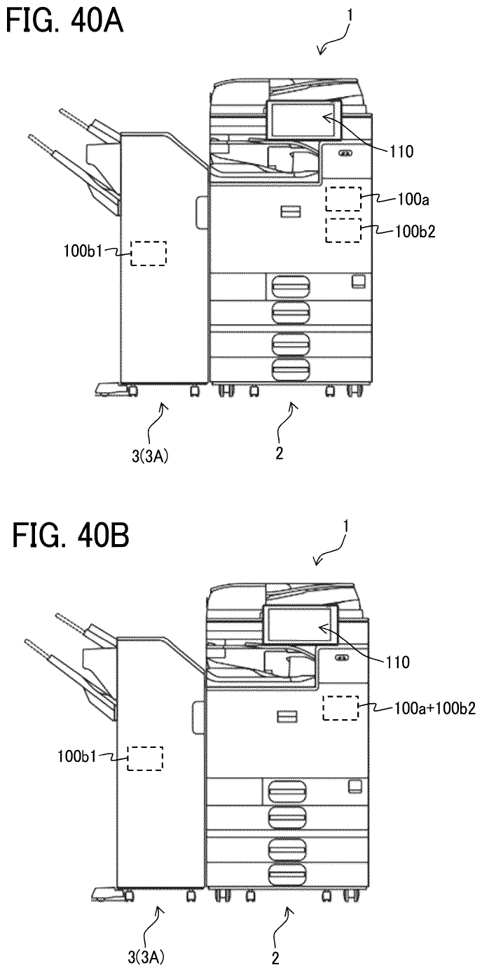

As illustrated in FIG. 40A, the controller 100b of the post-processing apparatus 3 may be divided into, for example, a controller 100b1 that controls a drive unit system such as a motor and a controller 100b2 that controls a detection unit system such as a sensor, in other words, for each function. Only one of the divided controllers 100b1 and 100b2, for example, the controller 100b2 of the post-processing apparatus 3A, may be provided on the image forming apparatus 2 side. Further, as illustrated in FIG. 40B, the controller 100b2 of the post-processing apparatus 3 disposed in the image forming apparatus 2 may be integrated with the controller 100a of the image forming apparatus 2.

### Second Embodiment of Post-Processing Apparatus

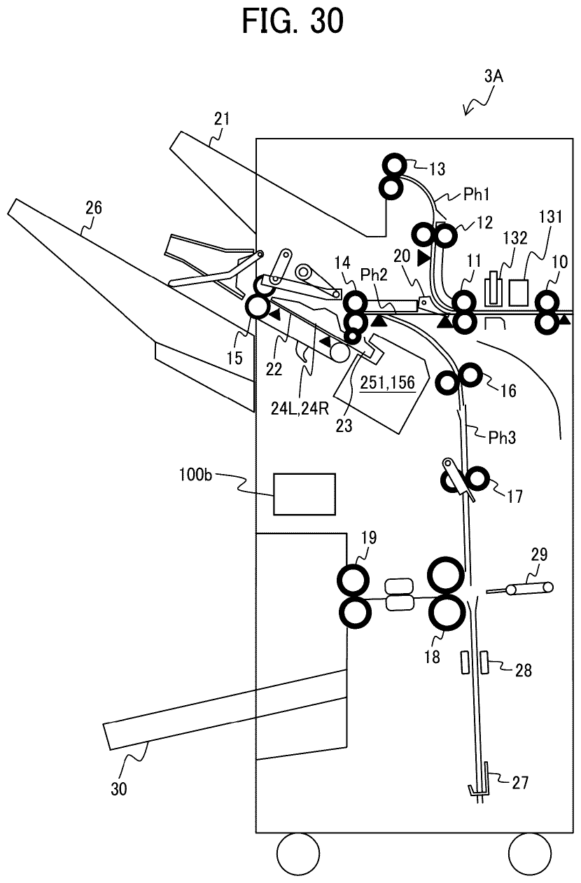

A description is given of a post-processing apparatus 3A according to a second embodiment, with reference to FIGS. 30 to 38.

Components common to those of the post-processing apparatus 3 according to the first embodiment are attached with the same or like reference signs, and detailed descriptions may be omitted.

An edge binder 251 of the post-processing apparatus 3A according to the second embodiment is different from the edge binder 25 of the post-processing apparatus 3 according to the first embodiment in which the liquid applier 31 and the crimper 32 are arranged side by side, in that the edge binder 251 includes a crimper 32′ only and a liquid applier 131 is disposed on the upstream side in a conveyance path. Such a configuration allows a given number of sheets P to be stacked after the liquid application process and conveyed to the crimper 32′ of the edge binder 251 disposed at a downstream position of the conveyance path in the direction in which the sheet P is conveyed. Accordingly, the productivity of the binding process performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P, in other words, the width direction of the sheet P is defined as the “main scanning direction”. The liquid application position on a sheet P or a sheet bundle Pb onto which liquid application is performed by the liquid applier 131 corresponds to the binding position on the sheet bundle Pb to be crimped by the crimper 32′. For this reason, in the following description, the liquid application position and the binding position are denoted by the same reference sign (B1).

FIG. 30 is a diagram illustrating an internal configuration of the post-processing apparatus 3A according to the second embodiment.

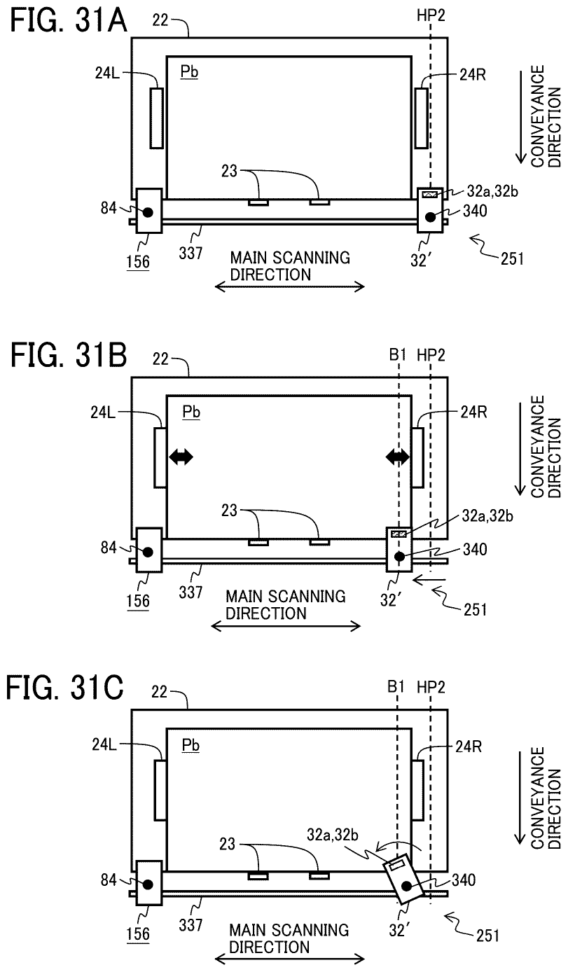

As illustrated in FIGS. 31A, 31B and 31C, the edge binder 251 includes the crimper 32′ alone. As illustrated in FIGS. 31A, 31B and 31C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and are movable in the main scanning direction.

Further, the crimper 32′ and the staple binder 156 are respectively rotatable in the forward and reverse directions about a crimper shaft 340 and a stapler shaft 84 both extending in the thickness direction of the sheet bundle Pb placed on the internal tray 22. In other words, the crimper 32′ and the staple binder 156 bind, at a desired angle, a desired position in the main scanning direction on the sheet bundle Pb placed on the internal tray 22 in, for example, corner oblique binding, parallel one-point binding, or parallel two-point binding.

The crimper 32′ presses and deforms the sheet bundle Pb with the serrated upper crimping teeth 32a and the serrated lower crimping teeth 32b to bind the sheet bundle Pb (denoted as “crimp binding”). On the other hand, the staple binder 156 passes the staple through a binding position on the sheet bundle Pb placed on the internal tray 22 to staple the sheet bundle Pb.

Each of FIGS. 31A, 31B and 31C is a view of the internal tray 22 in the thickness direction of the sheet bundle Pb.

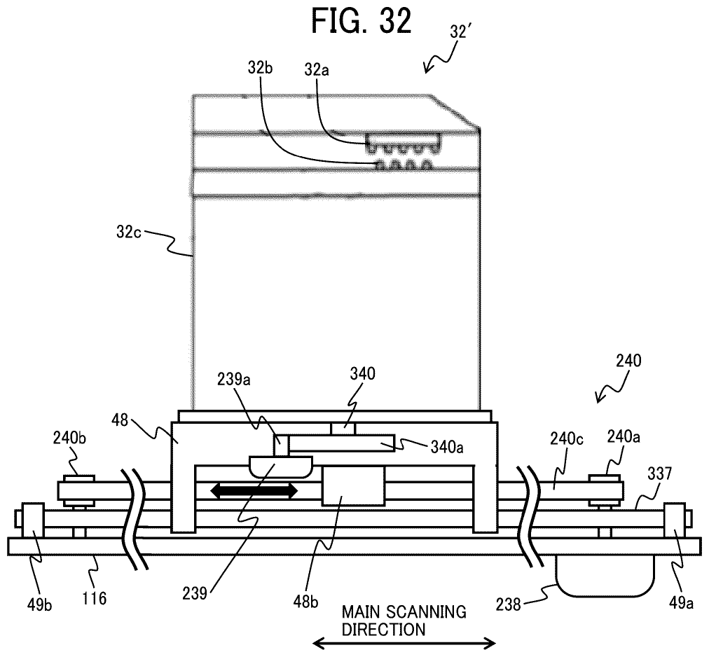

FIG. 32 is a schematic diagram illustrating the crimper 32′ as viewed from the downstream side in the conveyance direction.

As illustrated in FIGS. 31A to 31C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about the crimper shaft 340 extending in the thickness direction of the sheet bundle Pb placed on the internal tray 22.

Similarly, the staple binder 156 is movable in the main scanning direction of the sheet bundle Pb. The staple binder 156 is rotatable in the forward and reverse directions about the stapler shaft 84 extending in thickness direction of the sheet bundle Pb. Since the other components of the staple binder 156 are similar to those of the staple binder 155 (see FIG. 6) of the post-processing apparatus 3 according to the first embodiment, a detailed description thereof is omitted.

As illustrated in FIG. 32, the crimper 32′ includes a guide rail 337 extending in the main scanning direction at a position downstream from the internal tray 22 in the conveyance direction. The crimper 32′ includes a crimper movement motor 238 as a driving source. The base 48 supporting the crimping frame 32c has a fastening portion 48b for fastening the timing belt 240c at the bottom of the base 48. The driving force of the crimper movement motor 238 is transmitted to the base 48 by the drive transmission assembly 240 that includes the pulleys 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper shaft 340 including a drive transmission gear 340a is fixed to a bottom face of the crimping frame 32c that holds the components of the crimper 32′.

The crimper shaft 340 and the drive transmission gear 340a are held by the base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper shaft 340 via the output gear 239a and the drive transmission gear 340a, the crimper 32′ rotates in the forward and reverse directions on the base 48 about the crimper shaft 340 extending in the thickness direction of the sheet P placed on the internal tray 22. The guide rail 337, the crimper movement motor 238, the crimper pivot motor 239, the crimper shaft 340, and the drive transmission assembly 240 constitute at least part of a driving assembly of the crimper 32′ according to the present embodiment.

The crimper 32′ is movable between a standby position HP2 illustrated in FIG. 31A and a position where the crimper 32′ faces the first binding position B1 illustrated in FIGS. 31B and 31C. The standby position HP2 is a position deviated to one side in the main scanning direction from the sheet bundle Pb stacked on the internal tray 22. The first binding position B1 is a position on the sheet bundle Pb placed on the internal tray 22. However, the specific position of the first binding position B1 is not limited to the example of FIGS. 31A, 31B and 31C, and the first binding position B1 may be any one or more positions in the main scanning direction in a downstream end in the conveyance direction of the sheet P.

The posture of the crimper 32′ changes or is pivoted between a parallel binding posture illustrated in FIG. 31B and an oblique binding posture illustrated in FIG. 31C. In other words, the crimper 32′ is rotatable in the forward and reverse directions about the crimper shaft 340. The parallel binding posture is a posture of the crimper 32′ in which the longitudinal direction of the upper crimping teeth 32a and the lower crimping teeth 32b is along the main scanning direction. In other words, the posture of the crimper 32′is such that the longitudinal direction of a “rectangular crimp binding mark” is along the main scanning direction. The oblique binding posture is a posture of the crimper 32′ in which the longitudinal direction of the upper crimping teeth 32a and the lower crimping teeth 32b is inclined with respect to the main scanning direction. In other words, the posture of the crimper 32′ is such that the longitudinal direction of a “rectangular crimp binding mark” is inclined with respect to the main scanning direction.

The rotation angle in the oblique binding posture, in other words, the angle of the upper crimping teeth 32a and the lower crimping teeth 32b with respect to the main scanning direction is not limited to the example of FIG. 31C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132 as a processor. The liquid applier 131 and the hole punch 132 are disposed upstream from the internal tray 22 in the opposite conveyance direction. The liquid applier 131 and the hole punch 132 are disposed at different positions in the opposite conveyance direction to simultaneously face one sheet P that is conveyed by the conveyance roller pairs 10 to 19.

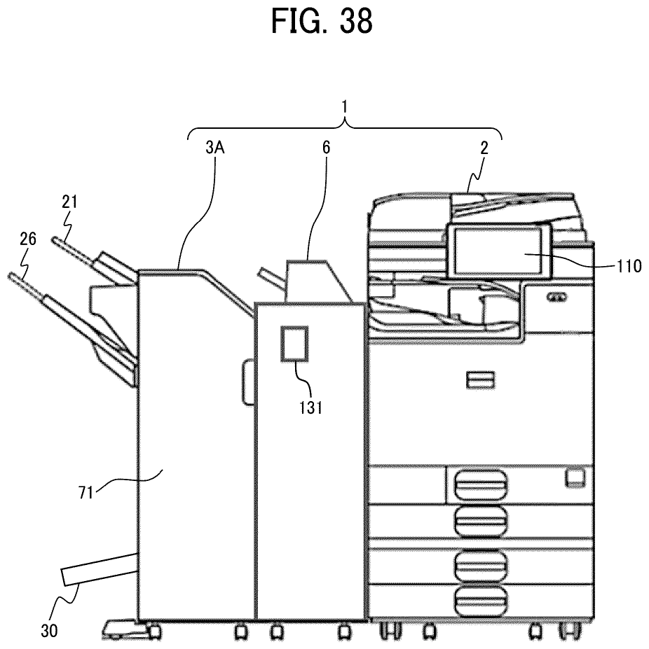

The liquid applier 131 and the hole punch 132 according to the present embodiment are disposed between the conveyance roller pair 10 and the conveyance roller pair 11. However, the arrangement of the liquid applier 131 is not limited to the example of FIG. 30. For example, in a case where an inserter 6 is disposed between the image forming apparatus 2 and the post-processing apparatus 3A as illustrated in FIG. 38, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

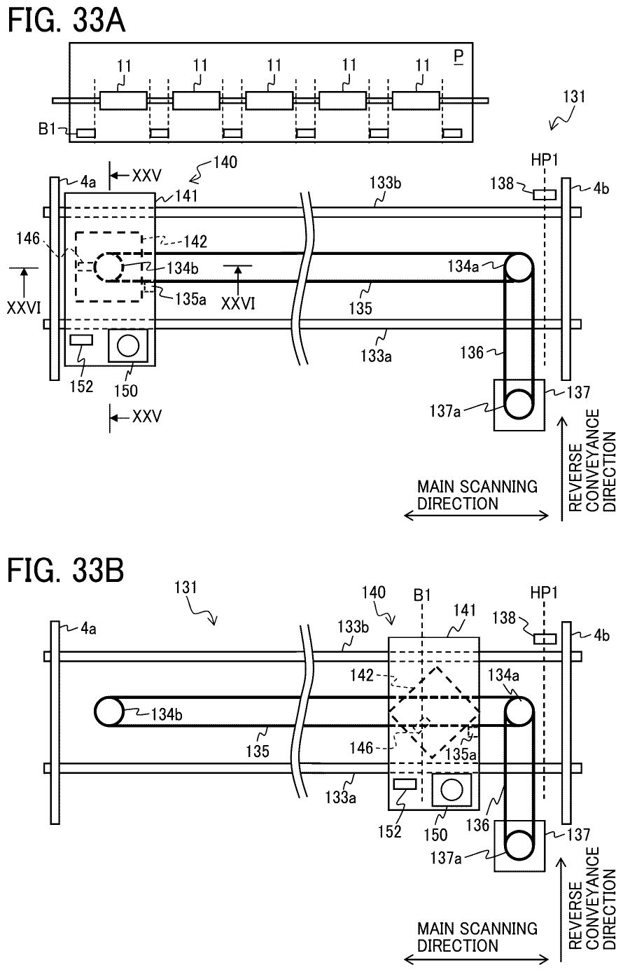

As illustrated in FIG. 33A, the conveyance roller pair 11 is located at a position at which the conveyance roller pair 11 does not overlap, in the main scanning direction, with the first liquid application position B1 on the sheet P to which liquid has been applied by a liquid application head 146 of the liquid applier 131. This arrangement is to prevent the amount of liquid at the first liquid application position B1 from decreasing due to multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet P is conveyed.

In addition, multiple paired rollers included in the conveyance roller pair 11 are located at positions at which the multiple roller pairs do not overlap with the first liquid application position B1 on the sheet P in the main scanning direction, which can thus prevent the conveying performance of the sheet P from being worse due to the adhesion of liquid to the roller pairs and further prevent a conveyance jam caused by the worsened conveying performance of the sheet P.

Although only the conveyance roller pair 11 has been described above, similarly, the roller pairs included in the conveyance roller pairs 14 and 15 are also preferably located at positions at which the roller pairs do not overlap with the first liquid application position B1 on the sheet P in the main scanning direction.

The liquid applier 131 applies liquid to the sheet P that is conveyed by the conveyance roller pair 10 and the conveyance roller pair 11 (denoted as “liquid application”). The hole punch 132 punches a hole in the sheet P that is conveyed by the conveyance roller pair 10 and the conveyance roller pair 11 such that the hole passes through the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pair 10 and the conveyance roller pair 11.

FIGS. 33A and 33B are views of the liquid applier 131 according to the second embodiment, viewed from the thickness direction of the sheet P.

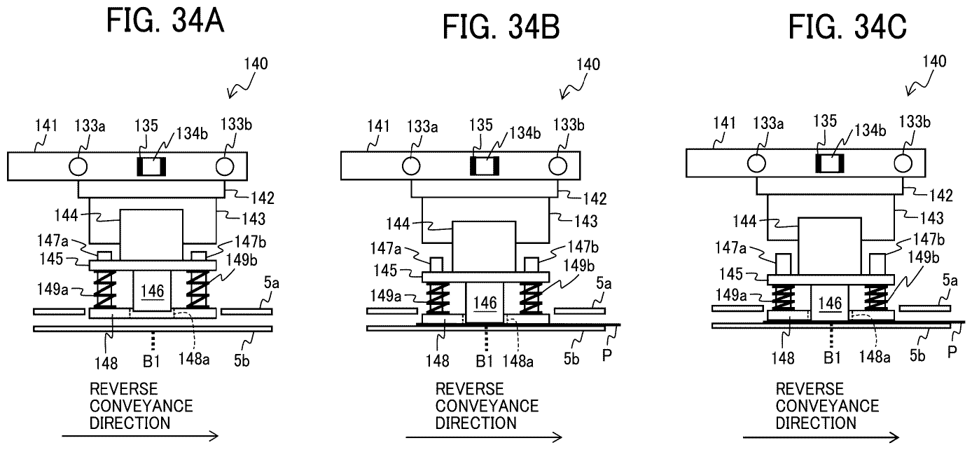

FIGS. 34A, 34B and 34C are views taken in the direction of arrows XXV-XXV in FIG. 33A.

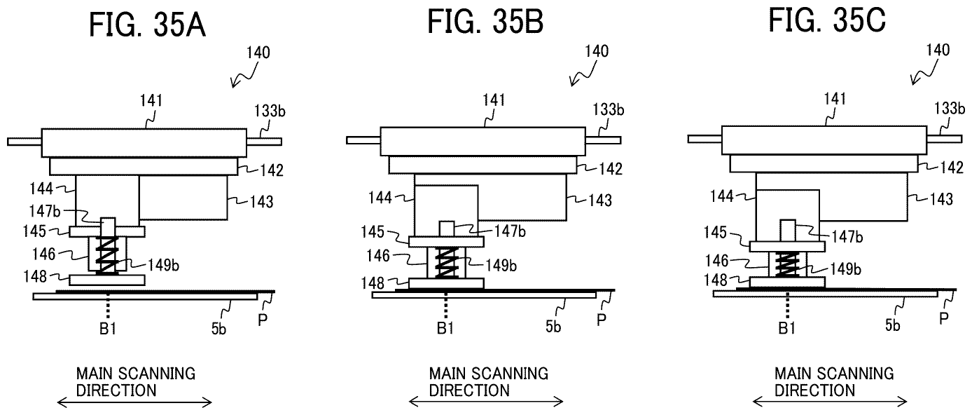

FIGS. 35A, 35B and 35C are views taken in the direction of arrows XXVI-XXVI in FIG. 33A.

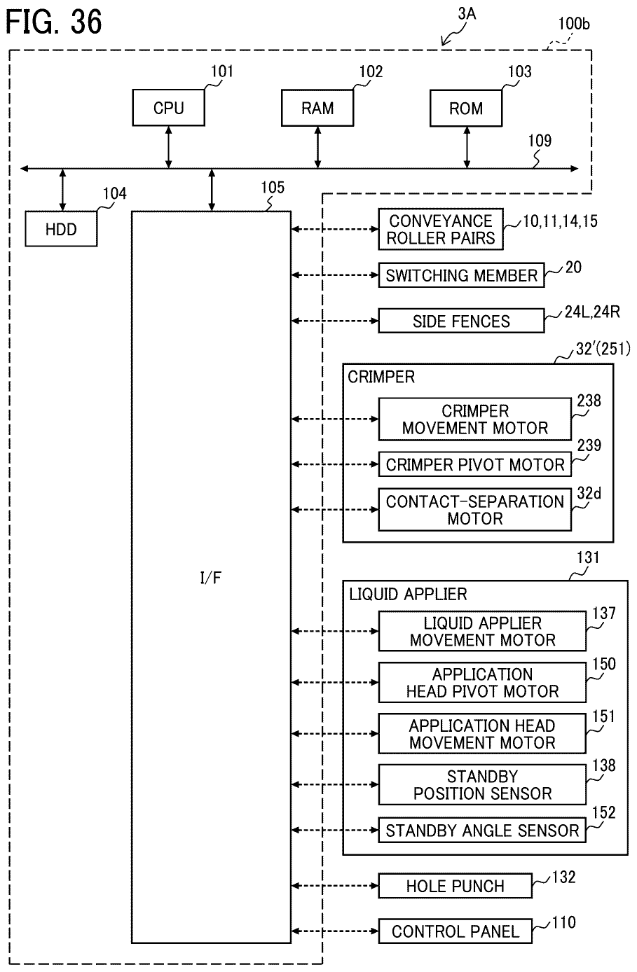

As illustrated in FIGS. 33A to 35C, the liquid applier 131 includes a pair of guide shafts 133a and 133b, a pair of pulleys 134a and 134b, endless annular belts 135 and 136, a liquid applier movement motor 137, a standby position sensor 138 (see FIG. 36), and a liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the guide shafts 133a and 133b in the opposite conveyance direction. On the other hand, the pulleys 134a and 134b are apart from each other in the main scanning direction. The pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a coupling portion 135a. The endless annular belt 136 is looped around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. Thus, the liquid application unit 140 moves in the main scanning direction along the pair of guide shafts 133a and 133b. The liquid application unit 140 reciprocates in the main scanning direction in response to switching of the rotation direction of the liquid applier movement motor 137.

The standby position sensor 138 detects that the liquid application unit 140 has reached a standby position HP1 (see FIGS. 33A and 33B) in the main scanning direction. The standby position sensor 138 then outputs a standby position signal indicating the detection result to the controller 100b, which will be described below with reference to FIG. 36. The standby position sensor 138 is, for example, an optical sensor including a light emitter and a light receiver. At the standby position HP1, the liquid application unit 140 blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 34A, 34B and 34C, the conveyance path inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed to face the sheet P conveyed on the conveyance path through the opening of the upper guide plate 5a.

As illustrated in FIGS. 33A to 35C, the liquid application unit 140 includes a base 141, a rotary bracket 142, a liquid storage tank 143, a liquid-application-head mover 144, a holding member 145, the liquid application head 146, columns 147a and 147b, a pressure plate 148, coil springs 149a and 149b, an application head pivot motor 150, an application head movement motor 151 (see FIG. 36), and a standby angle sensor 152 (see FIG. 36).

The base 141 is supported by the pair of guide shafts 133a and 133b so as to be slidable in the main scanning direction. The base 141 is coupled to the endless annular belt 135 by the coupling portion 135a. The base 141 supports the components (i.e., the rotary bracket 142, the liquid storage tank 143, the liquid-application-head mover 144, the holding member 145, the liquid application head 146, the columns 147a and 147b, the pressure plate 148, the coil springs 149a and 149b, the application head pivot motor 150, the application head movement motor 151, and the standby angle sensor 152) of the liquid application unit 140.

The rotary bracket 142 is attached to the lower face of the base 141 so as to be rotatable in the forward and reverse directions about an axis extending in the thickness direction of the sheet P. The rotary bracket 142 is rotated in the forward and reverse directions with respect to the base 141 by a driving force transmitted from the application head pivot motor 150. The rotary bracket 142 retains the liquid storage tank 143, the liquid-application-head mover 144, the holding member 145, the liquid application head 146, the columns 147a and 147b, the pressure plate 148, and the coil springs 149a and 149b.

The standby angle sensor 152 (see FIG. 36) detects that the rotary bracket 142 has reached a standby angle. The standby angle sensor 152 then outputs a standby angle signal indicating the detection result to the controller 100b. The standby angle is, for example, an angle for the parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 33A illustrates the rotary bracket 142 in a position for the parallel binding that is performed by the crimper 32′ disposed downstream from the liquid applier 131.

FIG. 33B illustrates the rotary bracket 142 in a position for the oblique binding (i.e., corner binding) that is performed by the crimper 32′ disposed downstream from the liquid applier 131.

The liquid storage tank 143 stores liquid to be applied to the sheet P. The liquid-application-head mover 144 is attached to the liquid storage tank 143 so as to be movable (for example, up and down) in the thickness direction of the sheet P. The liquid-application-head mover 144 moves in the thickness direction of the sheet P with respect to the liquid storage tank 143 by a driving force transmitted from the application head movement motor 151. The holding member 145 is attached to a lower end of the liquid-application-head mover 144. The liquid application head 146 projects from the holding member 145 toward the conveyance path (downward in the present embodiment). The liquid that is stored in the liquid storage tank 143 is supplied to the liquid application head 146. The liquid application head 146 is made of a material having a relatively high liquid absorption (for example, sponge or fiber).

The columns 147a and 147b project downward from the holding member 145 around the liquid application head 146. The columns 147a and 147b are movable relative to the holding member 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holding member 145 and the pressure plate 148. The coil springs 149a and 149b bias the columns 147a and 147b and the pressure plate 148 in a direction away from the holding member 145.

As illustrated in FIGS. 34A and 35A, before the sheet P is conveyed to the position where the sheet P faces the opening of the upper guide plate 5a, the pressure plate 148 is positioned at or above the opening. Subsequently, when the sheet P that is conveyed by the conveyance roller pair 10 and the conveyance roller pair 11 stops at a position where the first liquid application position B1 on the sheet P faces the opening, the application head movement motor 151 is rotated in a first direction. As a result, the liquid-application-head mover 144, the holding member 145, the liquid application head 146, the columns 147a and 147b, the pressure plate 148, and the coil springs 149a and 149b are moved down together to allow the pressure plate 148 to contact the sheet P. The first liquid application position B1 is a position to be crimped and bound by the crimper 32′included in the edge binder 251, in other words, the first binding position B1.

As the application head movement motor 151 keeps rotating in the first direction after the pressure plate 148 contacts the sheet P, the coil springs 149a and 149b are compressed to further move down the liquid-application-head mover 144, the holding member 145, the liquid application head 146, and the columns 147a and 147b. As illustrated in FIGS. 34B and 35B, the lower face of the liquid application head 146 contacts the sheet P through the through hole 148a. As a result, the liquid contained in the liquid application head 146 is applied to the sheet P.

Further rotation of the application head movement motor 151 in the first direction further strongly presses the liquid application head 146 against the sheet P as illustrated in FIGS. 34C and 35C. Accordingly, the amount of liquid that is applied to the sheet P increases. In short, the liquid applier 131 changes the pressing force of the liquid application head 146 against the sheet P to adjust the amount of liquid that is applied to the sheet P.

On the other hand, the rotation of the application head movement motor 151 in the second direction opposite to the first direction moves up the liquid-application-head mover 144, the holding member 145, the liquid application head 146, the columns 147a and 147b, the pressure plate 148, and the coil springs 149a and 149b together. As a result, as illustrated in FIGS. 34A and 35A, the liquid application head 146 and the pressure plate 148 are separated from the sheet P. In other words, the liquid applier 131 includes the liquid application head 146 that can be separated from the sheet P.

FIG. 36 is a hardware configuration diagram of a control block of the post-processing apparatus 3A according to the second embodiment.

As illustrated in FIG. 36, the post-processing apparatus 3A includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic device and controls the overall operation of the post-processing apparatus 3A. The RAM 102 is a volatile storage medium that allows data to be read and written at high speed. The CPU 101 uses the RAM 102 as a working area for data processing. The ROM 103 is a read-only non-volatile storage medium that stores programs such as firmware. The HDD 104 is a non-volatile storage medium that allows data to be read and written and has a relatively large storage capacity. The HDD 104 stores, for example, an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100b serving as a control device that controls the operation of the post-processing apparatus 3A.

The I/F 105 is an interface that connects the conveyance roller pairs 10, 11, 14, and 15, the switching member 20, the side fences 24L and 24R, the crimper movement motor 238, the crimper pivot motor 239, a contact-separation motor 32d, a liquid applier movement motor 137, an application head pivot motor 150, an application head movement motor 151, a standby position sensor 138, a standby angle sensor 152, a hole punch 132, and a control panel 110 to the common bus 109.

The controller 100b controls, via the I/F 105, the operations of the conveyance roller pairs 10, 11, 14, and 15, the switching member 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 36 mainly illustrates the components of the edge binder 251 and the liquid applier 131 including the crimper 32′ that executes the edge binding process, the components of the saddle binder 28 that executes the saddle binding process are controlled by the controller 100b like the components of the liquid applier 131 and the edge binder 251 (the crimper 32′) that executes the edge binding.

As illustrated in FIG. 38, the image forming apparatus 2 includes the control panel 110. The control panel 110 includes an operation unit that receives instructions from a user and a display serving as a notifier that notifies the user of information. The operation unit includes, for example, physical input buttons and a touch panel overlaid on a display. The control panel 110 acquires information from the user through the operation unit and provides the information to the user through the display. The notifier is not limited to the display and may be a light-emitting diode (LED) lamp or a speaker. The post-processing apparatus 3A may include a control panel 110 similar to the above-described control panel 110 of the image forming apparatus 2.

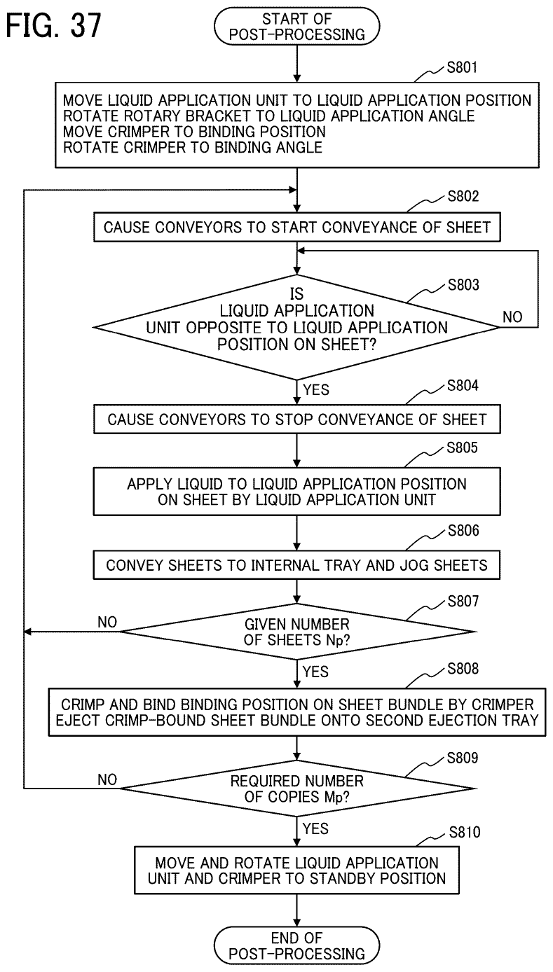

FIG. 37 is a flowchart of post-processing of the post-processing apparatus 3A according to the second embodiment. Specifically, FIG. 37 is a flowchart of a process in executing the one-point binding process illustrated in FIGS. 31A, 31B and 31C.

For example, the controller 100b executes the post-processing illustrated in FIG. 37 in response to acquisition of an instruction (denoted below as “post-processing command”) of executing the post-processing from the image forming apparatus 2. The post-processing command includes, for example, the number of sheets P of the sheet bundle Pb (denoted below as “given number of sheets Np”), the number of sheet bundles Pb to be subjected to binding process (denoted below as “requested number of copies Mp”), the first binding position B1 (corresponding to the first liquid application position B1), the angle of the first binding position B1 (corresponding to the angle of the first liquid application position B1), the type of binding process (parallel binding process or oblique binding process), and a process that is executed in parallel with the liquid application process (punching a hole in the present embodiment). At the start of the post-processing, the liquid application unit 140 is at the standby position HP1 (see FIGS. 33A and 33B), and the rotary bracket 142 is held at the standby angle (corresponding to “parallel binding posture”).

First, the controller 100b drives the liquid applier movement motor 137 to move the liquid application unit 140 (corresponding to a liquid application device) in the main scanning direction, thus causing the liquid application head 146 to move from the standby position HP1 to the position where the liquid application head 146 can face the first liquid application position B1 (see FIG. 33B, the position corresponding to the first binding position B1 illustrated in FIG. 31B and FIG. 31C). If the type of the binding process instructed by the post-processing command is “oblique binding process”, in step S801, the controller 100b drives the application head pivot motor 150 to rotate the rotary bracket 142. Thus, the liquid application head 146 is rotated from the standby angle to the liquid application angle corresponding to the “oblique binding posture”. It can be ascertained, based on pulse signals output from rotary encoders of the liquid applier movement motor 137 and the application head pivot motor 150, that the liquid application head 146 has reached the position where the liquid application head 146 can face the first liquid application position B1. In a case where the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

The controller 100b also drives the crimper movement motor 238 to move the crimper 32′ from the standby position HP2 to the position where the crimper 32′ can face the first binding position B1 as illustrated in FIGS. 31A and 31B (step S801). If the type of the binding process instructed by the post-processing command is “oblique binding process”, the controller 100b drives the crimper pivot motor 239 to rotate the crimper 32′ from the standby angle to the crimping angle corresponding to the “oblique binding posture” (step S801). It can be ascertained, based on pulse signals output from rotary encoders of the crimper movement motor 238 and the crimper pivot motor 239, that the crimper 32′ has reached the position where the crimper 32′ can face the first binding position B1. In a case where the type of the binding process instructed by the post-processing command is “parallel binding process”, the controller 100b omits the above-described operation of rotating the crimper 32′. In other words, the crimper 32′ moves in the main scanning direction while maintaining the standby angle.

Subsequently, in step S802, the controller 100b drives the conveyance roller pair 10 and the conveyance roller pair 11 to start conveying the sheet P on which an image is formed by the image forming apparatus 2. In step S803, the controller 100b determines whether the first liquid application position B1 on the sheet P has faced the liquid application unit 140 (more specifically, the liquid application head 146). When the controller 100b determines that the first liquid application position B1 on the sheet P has not faced the liquid application unit 140 (No in S803), the controller 100b continues causing the conveyance roller pair 10 and the conveyance roller pair 11 to convey the sheet P until the first liquid application position B1 on the sheet P faces the liquid application unit 140 (Yes in S803). When the controller 100b determines that the first liquid application position B1 on the sheet P has faced the liquid application head 146 (Yes in step S803), in step S804, the controller 100b causes the conveyance roller pair 10 and the conveyance roller pair 11 to stop conveying the sheet P. It can be ascertained, based on a pulse signal output from a rotary encoder of a motor that drives the conveyance roller pair 10 and the conveyance roller pair 11, that the first liquid application position B1 on the sheet P has faced the liquid application head 146.

The controller 100b causes the liquid application unit 140 to execute the process of applying liquid to the first liquid application position B1 on the sheet P (step S805). More particularly, the controller 100b rotates the application head movement motor 151 in the first direction to bring the liquid application head 146 into contact with the first liquid application position B1 on the sheet P. The controller 100b changes the pressing force of the liquid application head 146, in other words, the amount of rotation or rotation speed of the application head movement motor 151 depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotation of the application head movement motor 151 may be ascertained based on a pulse signal output from a rotary encoder of the application head movement motor 151.

In step S806, the controller 100b drives the conveyance roller pairs 10, 11, 14, and 15 to place a sheet P on the internal tray 22. In addition, the controller 100b reciprocates the side fences 24L and 24R in the main scanning direction to align the positions in the main scanning direction of the sheet P or the sheet bundle Pb stacked on the internal tray 22, in other words, execute so-called jogging process (step S806).

The controller 100b determines whether the number of sheets P placed on the internal tray 22 has reached the given number of sheets Np indicated by the post-processing command (step S807). When the controller 100b determines that the number of sheets P placed on the internal tray 22 has not reached the given number of sheets Np (No in step S807), the controller 100b executes the operations of steps S802 to S807 again until the number of sheets P placed on the internal tray 22 reaches the given number of sheets Np (Yes in step S807).

By contrast, when the controller 100b determines that the number of sheets P that are placed on the internal tray 22 has reached the given number of sheets Np (Yes in step S807), the controller 100b causes the crimper 32′ to crimp the first binding position B1 (corresponding to the first liquid application position B1 of the sheet P) on the sheet bundle Pb to which the liquid has been applied by the liquid application unit 140 (step S808). The controller 100b also rotates the conveyance roller pair 15 to eject the crimped and bound sheet bundle Pb to the second ejection tray 26 (step S808).

The controller 100b determines whether the number of sheet bundles Pb thus ejected to the second ejection tray 26 has reached the requested number of copies Mp indicated by the post-processing command (step S809). When the controller 100b determines that the number of the sheet bundles Pb ejected to the second ejection tray 26 has not reached the requested number of copies Mp (No in step S809), the controller 100b repeats the processing of steps S802 to S809 until the number of the sheet bundles Pb ejected to the second ejection tray 26 reaches the requested number of copies Mp (Yes in step S809).

When the controller 100b determines that the number of sheet bundles Pb ejected to the second ejection tray 26 reaches the requested number of copies Mp (Yes in step S809), in step S810, the controller 100b drives the liquid applier movement motor 137 to move the liquid application unit 140 to the standby position HP1 (see FIGS. 33A and 33B) and drives the crimper movement motor 238 to move the crimper 32′ to the standby position HP2 (see FIGS. 31A, 31B and 31C). When the posture instructed by the post-processing command is the “inclined binding posture”, the controller 100b drives the application head pivot motor 150 and the crimper pivot motor 239 to rotate the liquid application unit 140 and the crimper 32′into the parallel binding posture (corresponding to the standby angle) (step S810). By contrast, when the posture instructed by the post-processing command is the “parallel binding posture”, the controller 100b skips the aforementioned operation of rotating the liquid application unit 140 and the crimper 32′ to the parallel binding posture (corresponding to the standby angle). In steps S801 and S810, the execution order of the movement in the main scanning direction and the rotation in the forward and reverse directions of the liquid application unit 140 and the crimper 32′ is not limited to the aforementioned order and may be reversed.

The embodiments of the present disclosure are applied to the edge binder 25 that executes the edge binding process as described above. However, the embodiments of the present disclosure may be applied to the saddle binder 28 that executes the saddle binding process.

The configuration in which the controller 100b of the post-processing apparatus 3A according to the second embodiment illustrated in FIG. 30 is provided separately from the controller 100a of the image forming apparatus 2 similarly with FIG. 1 has been described, but it is not limited to such a configuration. For example, as illustrated in FIG. 39A, the controller 100b of the post-processing apparatus 3A may be disposed in the image forming apparatus 2. Further, as in the configuration of FIG. 39B, the controller 100b of the post-processing apparatus 3A may be integrated with the controller 100a of the image forming apparatus 2.

As in the configuration of FIG. 40A, the controller 100b of the post-processing apparatus 3A may be divided into, for example, a controller 100b1 that controls a drive unit system such as a motor and a controller 100b2 that controls a detection unit system such as a sensor, in other words, for each function. Only one of the divided controllers 100b1 and 100b2, for example, the controller 100b2 of the post-processing apparatus 3A, may be provided on the image forming apparatus 2 side. Further, as in the configuration of FIG. 40B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be executed by a computer causing an arithmetic device, a storage device, an input device, an output device, and a control device to operate in cooperation with each other based on a program. The program may be written in, for example, a storage device or a storage medium and distributed with the storage device or the storage medium, or may be distributed through, for example, an electric communication line.

The present disclosure is not limited to the above-exemplified embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents. Such modifications and variations are included in the technical scope described in the appended claims.

### Aspects of the Present Disclosure

Aspects of the present disclosure are, for example, as follows.

### Aspect 1

In Aspect 1, a medium processing apparatus includes a liquid applier, a first processing device. The liquid applier applies a liquid to a medium. The first processing device performs a first process on a medium bundle including the medium to which the liquid has been applied by the liquid applier. The liquid applier includes a liquid application member, a liquid storage tank, a liquid supply member, and a pressing member. The liquid application member applies the liquid by coming into contact with the medium. The liquid storage tank includes an internal space in which the liquid is stored and an elastic wall in which a part of an outer wall defining the internal space is elastically deformable in a direction of reducing a volume of the internal space. The liquid supply member supplies the liquid stored in the internal space to the liquid application member. The pressing member presses the elastic wall from an outside of the liquid storage tank.

### Aspect 2

In Aspect 2, the medium processing apparatus according to Aspect 1 further includes a conveyor and a first movement assembly. The conveyor conveys the medium in a conveyance direction. The first movement assembly moves the liquid applier in a main scanning direction orthogonal to the conveyance direction. The elastic wall is provided on an outer wall orthogonal to the main scanning direction. The pressing member is provided on a movement path of the liquid applier in the main scanning direction.

### Aspect 3

In Aspect 3, the medium processing apparatus according to Aspect 1 or 2 further includes a second processing device and a second movement assembly. The second processing device performs a second process on the medium bundle. The second movement assembly moves the second processing device in a main scanning direction orthogonal to a conveyance direction of the medium independently of the liquid applier. The pressing member is provided in the second processing device at a position facing the elastic wall in the main scanning direction.

### Aspect 4

In Aspect 4, in the medium processing apparatus according to Aspect 1 or 2, the pressing member is held by the liquid applier so as to be movable in a main scanning direction orthogonal to a conveyance direction of the medium at a position facing the elastic wall. The medium processing apparatus further includes a biasing member, a second processing device, and a second movement assembly. The biasing member biases the pressing member in a direction of separating the pressing member from the elastic wall. The second processing device performs a second process on the medium bundle. The second movement assembly moves the second processing device in the main scanning direction independently of the liquid applier. The pressing member is pressed by the second processing device moving in a direction approaching the liquid applier to press the elastic wall against a biasing force of the biasing member.

### Aspect 5

In Aspect 5, the medium processing apparatus according to Aspect 1 further includes a pivot mechanism that rotates the first processing device about a rotation shaft extending in a thickness direction of the medium between a first posture in which the first processing device comes in contact with the liquid applier and a second posture in which the first processing device is separated from the liquid applier. The pressing member is provided in the first processing device so that the first processing device presses the elastic wall in the first posture.

### Aspect 6

In Aspect 6, the medium processing apparatus according to Aspect 1 further includes a drive source that moves the pressing member between a pressing position where the pressing member presses the elastic wall and a separated position where the pressing member is separated from the elastic wall.

### Aspect 7

In Aspect 7, the medium processing apparatus according to Aspect 1 further include a third movement assembly that moves the liquid applier in a thickness direction of the medium between a contact position at which the liquid application member is in contact with the medium and a separated position at which the liquid application member is separated from the medium. The elastic wall is provided on an outer wall of the liquid applier orthogonal to the thickness direction of the medium. The pressing member presses the elastic wall when the liquid applier is at the contact position.

### Aspect 8

In Aspect 8, in the medium processing apparatus according to any one of Aspects 1 to 7, the pressing member presses the elastic wall when power supply to the medium processing apparatus is started or while the liquid is applied to the medium.

### Aspect 9

In Aspect 9, an image forming system includes an image forming apparatus that forms an image on a medium, and the medium processing apparatus according to any one of Aspects 1 to 8.

### Aspect 10

In Aspect 10, a medium processing apparatus includes a liquid applier and a processing device. The liquid applier applies apply liquid to a medium. The processing device performs a process on a medium bundle including the medium to which the liquid has been applied by the liquid applier. The liquid applier includes a liquid application member, a liquid storage tank, a liquid supplier, and a presser. The liquid application member contacts with the medium and apply the liquid to the medium. The liquid storage tank has an internal space, an outer wall, a liquid supplier, and a presser. The internal space stores the liquid. The outer wall defines the internal space, the outer wall having an elastic wall elastically deformable to reduce a volume of the internal space. The liquid supplier supplies the liquid stored in the internal space of the liquid storage tank to the liquid application member. The presser presses the elastic wall from outside the liquid storage tank to reduce the volume of the internal space.

### Aspect 11

In Aspect 11, the medium processing apparatus according to Aspect 10 further includes a conveyor and a movement assembly. The conveyor conveys the medium in a conveyance direction. The movement assembly moves the liquid applier along a movement path in a main scanning direction orthogonal to the conveyance direction. The elastic wall is in a plane orthogonal to the main scanning direction. The presser moves along the movement path of the liquid applier in the main scanning direction.

### Aspect 12

In Aspect 12, the medium processing apparatus according to Aspect 10 or 11 further includes another processing device and another movement assembly. Said another processing device performs another process on the medium bundle. Said another movement assembly moves said another processing device in the main scanning direction, independently of the movement assembly to move the liquid applier. Said another processing device includes the presser at a position facing the elastic wall in the main scanning direction.

### Aspect 13

In Aspect 13, the medium processing apparatus according to Aspect 10 or 11 further includes a biasing member, another processing device, and another movement assembly. The biasing member biases the presser in a direction of separating the presser from the elastic wall. Said another processing device to perform another process on the medium bundle. Said another movement assembly to move said another processing device in the main scanning direction, independently of the movement assembly to move the liquid applier. The liquid applier holds the presser facing the elastic wall and movable in the main scanning direction. Said another processing device moves in the main scanning direction to press the presser to press the elastic wall against a biasing force of the biasing member.

### Aspect 14

In Aspect 14, the medium processing apparatus according to Aspect 10 further includes a pivot mechanism to rotate the processing device about a rotation shaft extending in a thickness direction of the medium. The pivot mechanism rotates the processing device between a first posture in which the processing device contacts the liquid applier and a second posture in which the processing device is separated from the liquid applier. The processing device includes the presser to press the elastic wall when the processing device is in the first posture.

### Aspect 15

In Aspect 15, the medium processing apparatus according to Aspect 10 further includes a drive source to move the presser between a pressing position where the presser presses the elastic wall and a separated position where the presser is separated from the elastic wall.

### Aspect 16

In Aspect 16, the medium processing apparatus according to Aspect 10 further include another movement assembly to move the liquid applier in a thickness direction of the medium between a contact position at which the liquid application member is in contact with the medium and a separated position at which the liquid application member is separated from the medium. The elastic wall is on the outer wall of the liquid applier orthogonal to the thickness direction of the medium. The presser presses the elastic wall when the liquid applier is at the contact position.

### Aspect 17

In Aspect 17, in the medium processing apparatus according to any one of Aspects 10 to 16, the presser presses the elastic wall in response to a start of a power supply to the medium processing apparatus.

### Aspect 18

In Aspect 18, in the medium processing apparatus according to any one of Aspects 10 to 16, the presser presses the elastic wall during an application of the liquid to the medium.

### Aspect 19

In Aspect 19, an image forming system includes an image forming apparatus to form an image on a medium, and the medium processing apparatus according to any one of Aspects 10 to 18 to process the medium having the image formed by the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a liquid applier to apply liquid to a medium; and
a processing device to perform a process on a medium bundle including the medium to which the liquid has been applied by the liquid applier,
wherein the liquid applier includes:
a liquid application member to contact with the medium and apply the liquid to the medium;
a liquid storage tank having:
an internal space storing the liquid; and
an outer wall defining the internal space, the outer wall having an elastic wall elastically deformable to reduce a volume of the internal space;
a liquid supplier to supply the liquid stored in the internal space of the liquid storage tank to the liquid application member; and
a presser to press the elastic wall from outside the liquid storage tank to reduce the volume of the internal space.

2. The medium processing apparatus according to claim 1, further comprising:
a conveyor to convey the medium in a conveyance direction; and
a movement assembly to move the liquid applier along a movement path in a main scanning direction orthogonal to the conveyance direction,
wherein the elastic wall is in a plane orthogonal to the main scanning direction, and
the presser moves along the movement path of the liquid applier in the main scanning direction.

3. The medium processing apparatus according to claim 2, further comprising:
another processing device to perform another process on the medium bundle; and
another movement assembly to move said another processing device in the main scanning direction, independently of the movement assembly to move the liquid applier,
wherein said another processing device includes the presser at a position facing the elastic wall in the main scanning direction.

4. The medium processing apparatus according to claim 2, further comprising:
a biasing member to bias the presser in a direction of separating the presser from the elastic wall;
another processing device to perform another process on the medium bundle; and
another movement assembly to move said another processing device in the main scanning direction, independently of the movement assembly to move the liquid applier,
wherein the liquid applier holds the presser facing the elastic wall and movable in the main scanning direction; and
said another processing device moves in the main scanning direction to press the presser to press the elastic wall against a biasing force of the biasing member.

5. The medium processing apparatus according to claim 1, further comprising:
a pivot mechanism to rotate the processing device about a rotation shaft extending in a thickness direction of the medium,
wherein the pivot mechanism rotates the processing device between:
a first posture in which the processing device contacts the liquid applier; and
a second posture in which the processing device is separated from the liquid applier, and
the processing device includes the presser to press the elastic wall when the processing device is in the first posture.

6. The medium processing apparatus according to claim 1, further comprising a drive source to move the presser between:
a pressing position where the presser presses the elastic wall; and
a separated position where the presser is separated from the elastic wall.

7. The medium processing apparatus according to claim 1, further comprising another movement assembly to move the liquid applier in a thickness direction of the medium between:
a contact position at which the liquid application member is in contact with the medium; and
a separated position at which the liquid application member is separated from the medium,
wherein the elastic wall is on the outer wall of the liquid applier orthogonal to the thickness direction of the medium, and
the presser presses the elastic wall when the liquid applier is at the contact position.

8. The medium processing apparatus according to claim 1,
wherein the presser presses the elastic wall in response to a start of a power supply to the medium processing apparatus.

9. The medium processing apparatus according to claim 1,
wherein the presser presses the elastic wall during an application of the liquid to the medium.

10. An image forming system comprising:
an image forming apparatus to form an image on a medium; and
the medium processing apparatus according to claim 1 to process the medium having the image formed by the image forming apparatus.
